(19) United States
(12) Patent Application Publication
(10) Pub. No.: US 2026/0011942 A1
(43) Pub. Date: Jan. 8, 2026

(54) BOARD-TO-BOARD CONNECTOR WITH IMPROVED GROUND FEATURES

(71) Applicant: Luxshare Precision Industry Company Limited, SHENZHEN (CN)

(72) Inventors: Chien-Yu HSU, SHENZHEN (CN); Hui-Hsueh CHIANG, SHENZHEN (CN); Chi-Wei LIN, SHENZHEN (CN)

(73) Assignee: Luxshare Precision Industry Company Limited, SHENZHEN (CN)

(21) Appl. No.: 18/929,898

(22) Filed: Oct. 29, 2024

(30) Foreign Application Priority Data
Jul. 8, 2024 (CN) 202410910649.0
Jul. 22, 2024 (CN) 202421739961.X

(51) Int. Cl. H01R 12/71; H01R 13/24; H01R 13/6595; H01R 13/6596

(52) U.S. Cl. CPC H01R 12/714; H01R 13/2435; H01R 13/6595; H01R 13/6596

(57) ABSTRACT

A board-to-board connector includes an insulating body, a number of conductive terminals and a first ground sheet. The insulating body includes a first mounting surface, a second mounting surface and a terminal installation area. The terminal installation area includes a first outer side surface. The conductive terminals are mounted to the terminal installation area. The conductive terminal includes a first contact elastic arm extending beyond the first mounting surface and a second contact elastic arm extending beyond the second mounting surface. The first ground sheet is fixed to the insulating body. The first ground sheet includes a first main body portion covering at least part of the first outer side surface.

### CROSS-REFERENCE TO RELATED APPLICATIONS

This patent application claims priority of a Chinese Patent Application No. 202410910649.0, filed on Jul. 8, 2024 and titled “BOARD-TO-BOARD CONNECTOR”, and a Chinese Patent Application No. 202421739961.X, filed on Jul. 22, 2024 and titled “BOARD-TO-BOARD CONNECTOR”, the entire content of which is incorporated herein by reference.

### TECHNICAL FIELD

The present disclosure relates to a board-to-board connector, which belongs to the technical field of connectors.

### BACKGROUND

Board-to-board connectors in the related art generally include an insulating body and a plurality of conductive terminals fixed to the insulating body. Each conductive terminal includes a first contact elastic arm protruding beyond the insulating body and a second contact elastic arm protruding beyond the insulating body. The first contact elastic arm is configured to abut against the first circuit board to achieve electrical connection. The second contact elastic arm is configured to abut against the second circuit board to achieve electrical connection.

With the continuous improvement of signal transmission requirements for board-to-board connectors, how to reduce crosstalk among signals is a technical problem to be solved by those of ordinary skill in the art.

To this end, it is proposed in the related art to open a plurality of slits on the insulating body, and to install a plurality of ground isolation sheets in the slits. After installation, one ground isolation sheet is provided between two adjacent rows of conductive terminals to improve the ground shielding effect. However, considering issues such as terminal density and structural strength of the insulating body, on the one hand, the insulating body in the related art may not have enough space to form the slits; and on the other hand, when the insulating body itself is already thin, it is difficult to process the slits, and it is easy to cause substantial damage to the structural strength of the insulating body itself.

Therefore, how to optimize board-to-board connectors in related technologies is a technical problem that needs to be solved by those skilled in the art.

### SUMMARY

An object of the present disclosure is to provide a board-to-board connector with improved ground features.

In order to achieve the above object, the present disclosure adopts the following technical solution: a board-to-board connector, including: an insulating body, the insulating body including a first mounting surface, a second mounting surface disposed opposite to the first mounting surface along a first direction, and a terminal installation area; the terminal installation area including a first outer side surface; a plurality of conductive terminals, the plurality of conductive terminal being mounted to the terminal installation area; each conductive terminal including a first contact elastic arm extending beyond the first mounting surface and a second contact elastic arm extending beyond the second mounting surface; the first contact elastic arm being configured to be electrically connected to a first circuit board; the second contact elastic arm being configured to be electrically connected to a second circuit board; and a first ground sheet, the first ground sheet being fixed to the insulating body, the first ground sheet including a first main body portion covering at least part of the first outer side surface, a first ground elastic arm extending directly or indirectly from the first main body portion and protruding beyond the first mounting surface, and a second ground elastic arm extending directly or indirectly from the first main body portion and protruding beyond the second mounting surface; the first ground elastic arm being configured to be in contact with the first circuit board; the second ground elastic arm being configured to be in contact with the second circuit board.

Compared with the prior art, the terminal installation area of the present disclosure includes the first outer side surface. The board-to-board connector includes the first ground sheet. The first ground sheet is fixed to the insulating body. The first ground sheet includes the first main body portion covering at least part of the first outer side surface, the first ground elastic arm extending beyond the first mounting surface, and the second ground elastic arm extending beyond the second mounting surface. With this arrangement, the board-to-board connector of the present disclosure can relatively reliably mount the first ground sheet to the insulating body, minimize damage to the structural strength of the insulating body, and is suitable for thin board-to-board connectors.

In order to achieve the above object, the present disclosure adopts the following technical solution: a board-to-board connector, including: an insulating body, the insulating body including a terminal installation area, the terminal installation area including a first surface, a second surface opposite to the first surface along a first direction, and a first outer side surface; a plurality of conductive terminals, the plurality of conductive terminals being mounted to the terminal installation area, each conductive terminal including a first contact elastic arm extending beyond the first surface and a second contact elastic arm extending beyond the second surface; the first contact elastic arm being configured to be electrically connected to a first circuit board; the second contact elastic arm being configured to be electrically connected to a second circuit board; and a wave-absorbing material, the wave-absorbing material being provided on the insulating body, the wave-absorbing material including a first wave-absorbing plate portion covering at least part of the first outer side surface; the first wave-absorbing plate portion being disposed adjacent to a ground portion of the first circuit board and/or adjacent to a ground portion of the second circuit board.

Compared with the prior art, the terminal installation area of the present disclosure includes the first outer side surface. The board-to-board connector includes the wave-absorbing material. The wave-absorbing material includes the first wave-absorbing plate portion covering at least part of the first outer side surface. The first wave-absorbing plate portion is disposed adjacent to the ground portion of the first circuit board and/or adjacent to the ground portion of the second circuit board. With this arrangement, the board-to-board connector of the present disclosure can absorb the noise leaked out of the board-to-board connector through the first wave-absorbing plate portion when the conductive terminals transmit signals, thereby improving the quality of signal transmission. Besides, the wave-absorbing material of the present disclosure is disposed on an outer side the board-to-board connector, thereby minimizing damage to the structural strength of the insulating body, and is suitable for thin board-to-board connectors.

### BRIEF DESCRIPTION OF DRAWINGS

FIG. 1 is a perspective view of a board-to-board connector in accordance with a first embodiment of the present disclosure;

FIG. 2 is a perspective view of FIG. 1 from another angle;

FIG. 3 is a front view of FIG. 1;

FIG. 4 is a rear view of FIG. 1;

FIG. 5 is a partial enlarged view of a frame part B in FIG. 3;

FIG. 6 is a partial enlarged view of a frame part C in FIG. 4;

FIG. 7 is a top view of FIG. 1;

FIG. 8 is a bottom view of FIG. 1;

FIG. 9 is a partially exploded perspective view of FIG. 1;

FIG. 10 is a partially exploded perspective view of FIG. 9 from another angle;

FIG. 11 is a further partially exploded perspective view of FIG. 9;

FIG. 12 is a partially exploded perspective view of FIG. 11 from another angle;

FIG. 13 is a schematic cross-sectional view taken along line D-D in FIG. 7, wherein a first circuit board and a second circuit board are indicated by dotted lines;

FIG. 14 is a schematic cross-sectional view taken along line E-E in FIG. 3;

FIG. 15 is a perspective view of the board-to-board connector in accordance with a second embodiment of the present disclosure;

FIG. 16 is a perspective view of FIG. 15 from another angle;

FIG. 17 is a partially exploded perspective view of FIG. 15;

FIG. 18 is a partially exploded perspective view of FIG. 17 from another angle;

FIG. 19 is a schematic perspective view of the board-to-board connector in accordance with a third embodiment of the present disclosure;

FIG. 20 is a perspective view of FIG. 19 from another angle;

FIG. 21 is a partially exploded perspective view of FIG. 19;

FIG. 22 is a partially exploded perspective view of FIG. 21 from another angle;

FIG. 23 is a schematic cross-sectional view taken along line F-F in FIG. 19;

FIG. 24 is a schematic perspective view of the board-to-board connector in accordance with a fourth embodiment of the present disclosure;

FIG. 25 is a perspective view of FIG. 24 from another angle;

FIG. 26 is a front view of FIG. 24;

FIG. 27 is a rear view of FIG. 24;

FIG. 28 is a partially exploded perspective view of FIG. 24;

FIG. 29 is a partially exploded perspective view of FIG. 28 from another angle;

FIG. 30 is a perspective view of the board-to-board connector in accordance with a fifth embodiment of the present disclosure;

FIG. 31 is a perspective view of FIG. 30 from another angle;

FIG. 32 is a top view of FIG. 30;

FIG. 33 is a bottom view of FIG. 30;

FIG. 34 is a partially exploded perspective view of FIG. 30;

FIG. 35 is a partially exploded perspective view of FIG. 34 from another angle;

FIG. 36 is a schematic cross-sectional view taken along line G-G in FIG. 32, wherein the first circuit board and the second circuit board are indicated by dotted lines;

FIG. 37 is a schematic cross-sectional view of the first circuit board and the second circuit board in FIG. 36 after they are installed in place;

FIG. 38 is a partial enlarged view of a frame part H in FIG. 36;

FIG. 39 is a partial enlarged view of a frame part I in FIG. 37;

FIG. 40 is a schematic perspective view of the board-to-board connector in accordance with a sixth embodiment of the present disclosure;

FIG. 41 is a perspective view of FIG. 40 from another angle;

FIG. 42 is a top view of FIG. 40;

FIG. 43 is a bottom view of FIG. 40;

FIG. 44 is a partially exploded perspective view of FIG. 40;

FIG. 45 is a partially exploded perspective view of FIG. 44 from another angle;

FIG. 46 is a perspective view of the board-to-board connector in accordance with a seventh embodiment of the present disclosure;

FIG. 47 is a perspective view of FIG. 46 from another angle;

FIG. 48 is a top view of FIG. 46;

FIG. 49 is a bottom view of FIG. 46;

FIG. 50 is a partially exploded perspective view of FIG. 46; and

FIG. 51 is a partially exploded perspective view of FIG. 50 from another angle.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

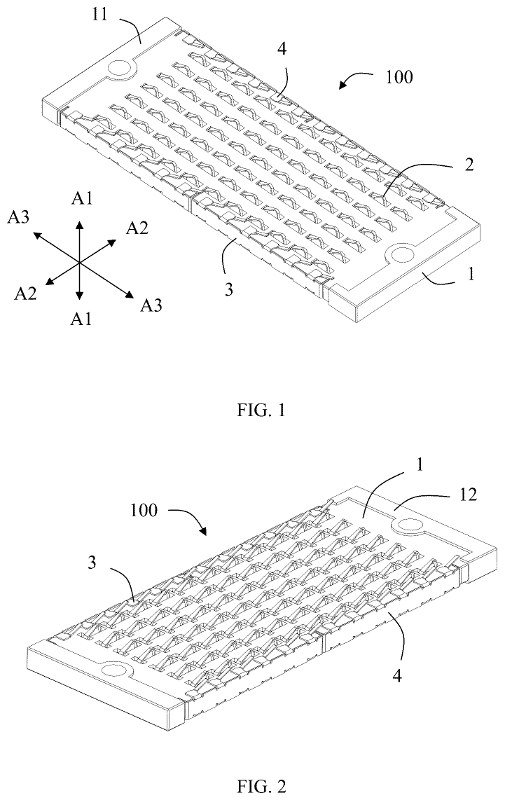

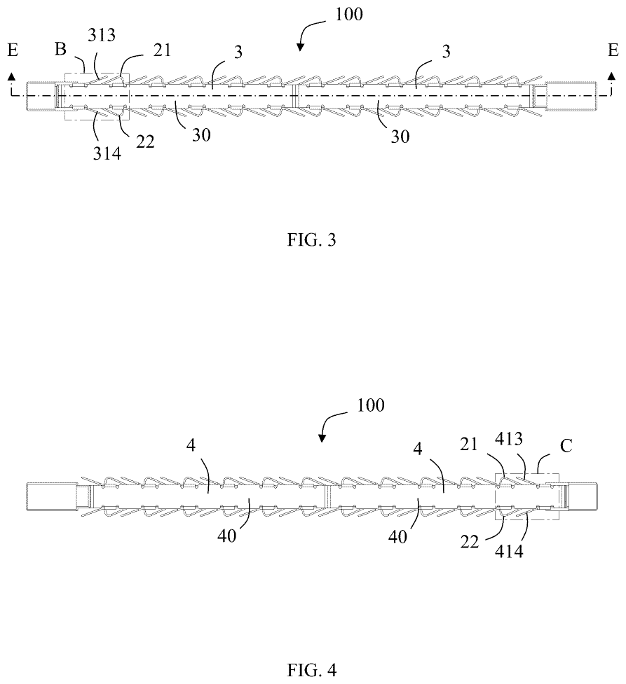

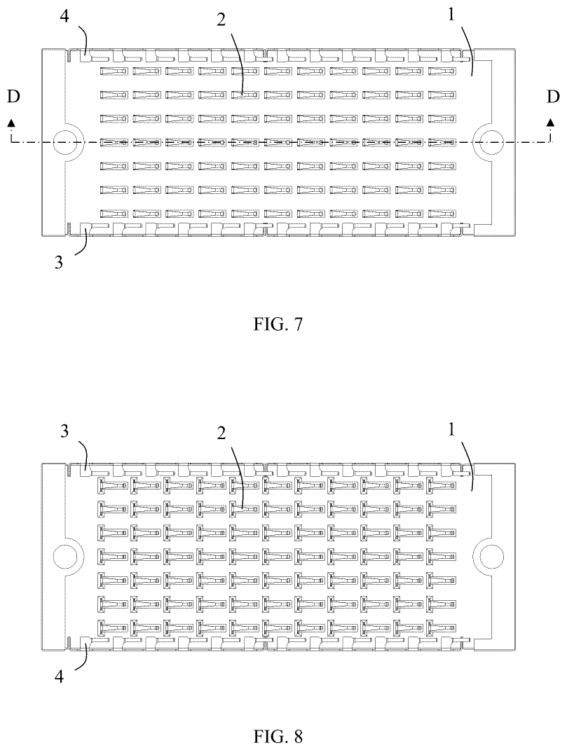

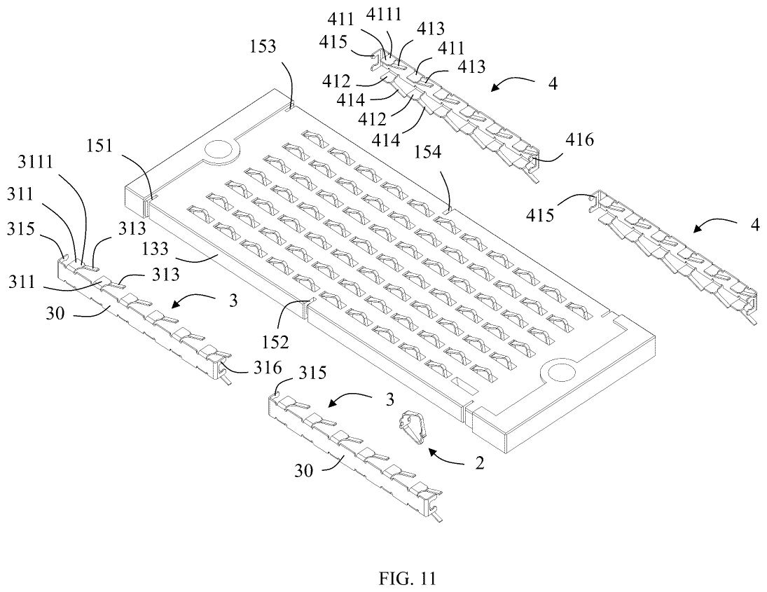

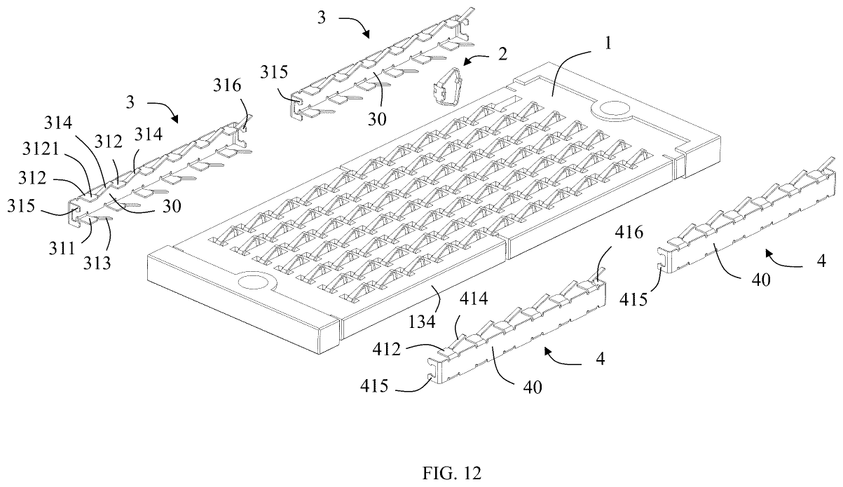

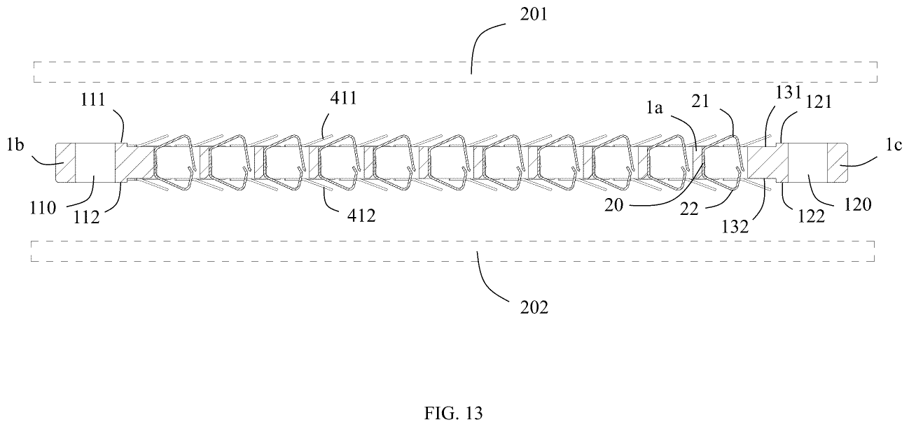

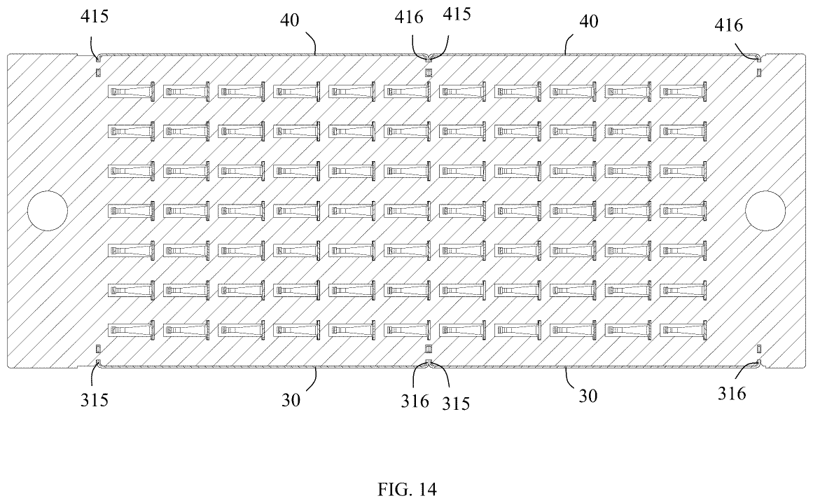

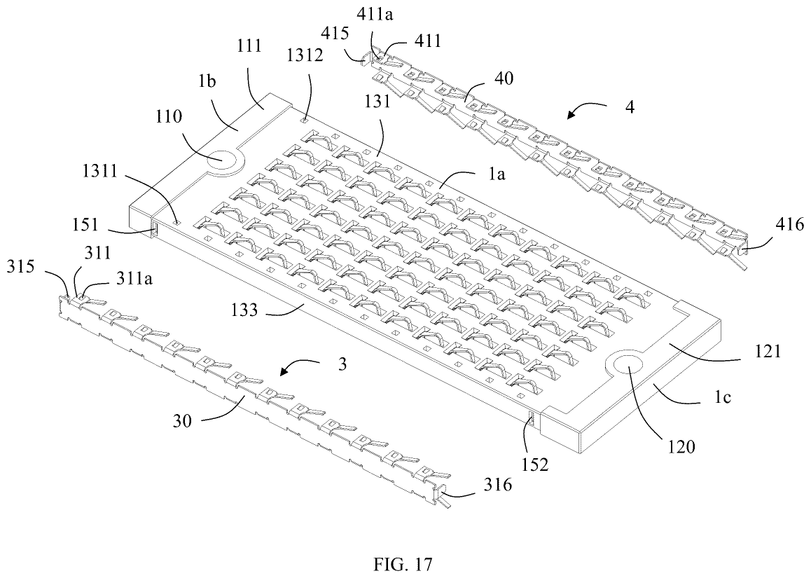

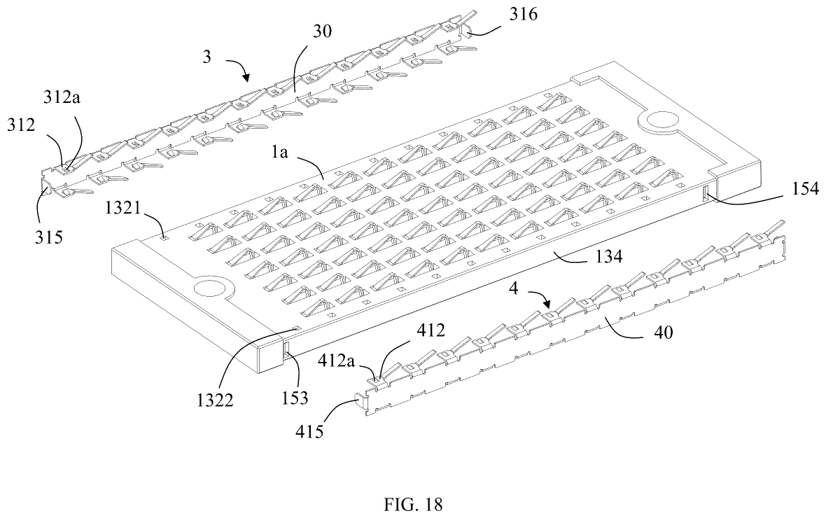

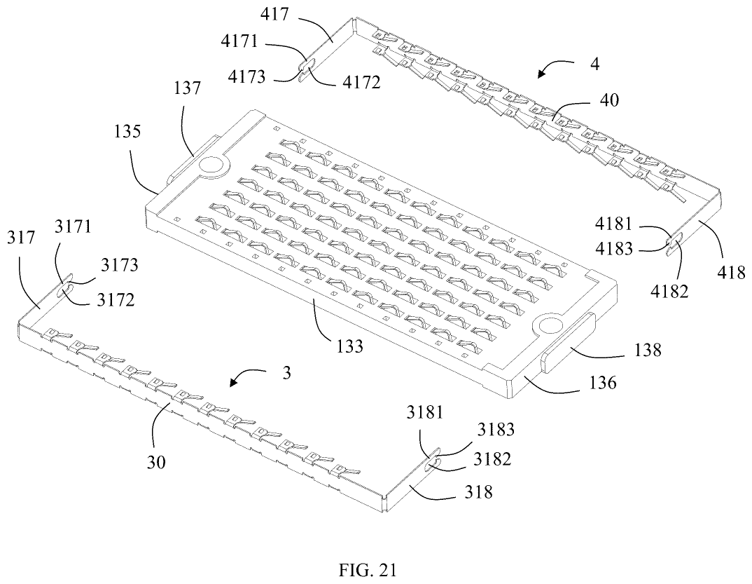

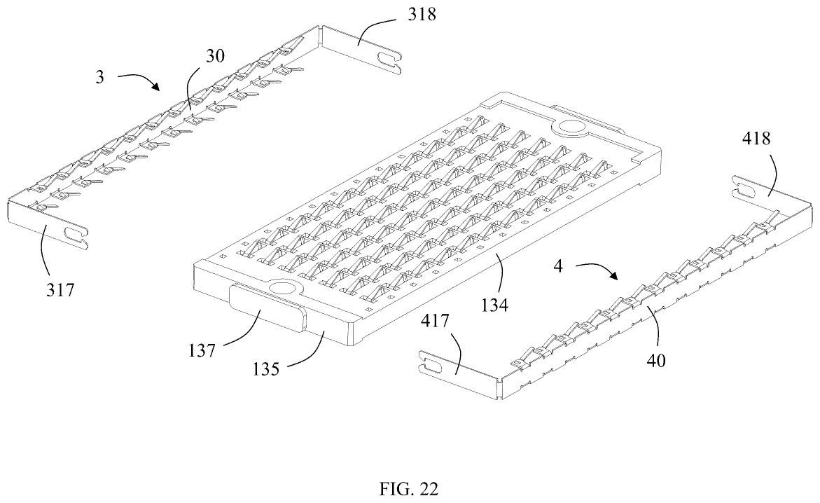

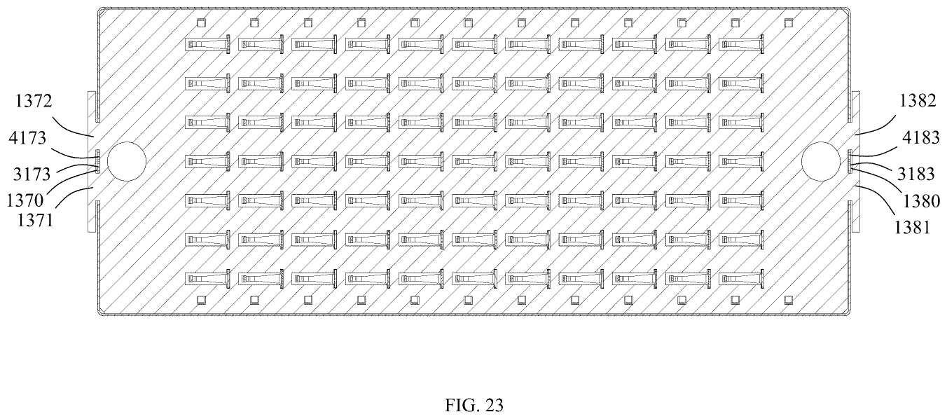

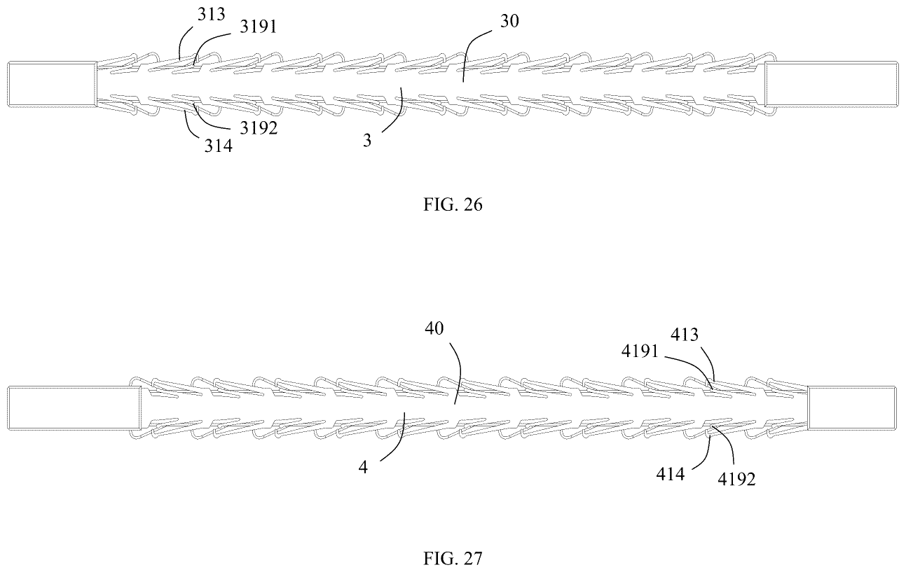

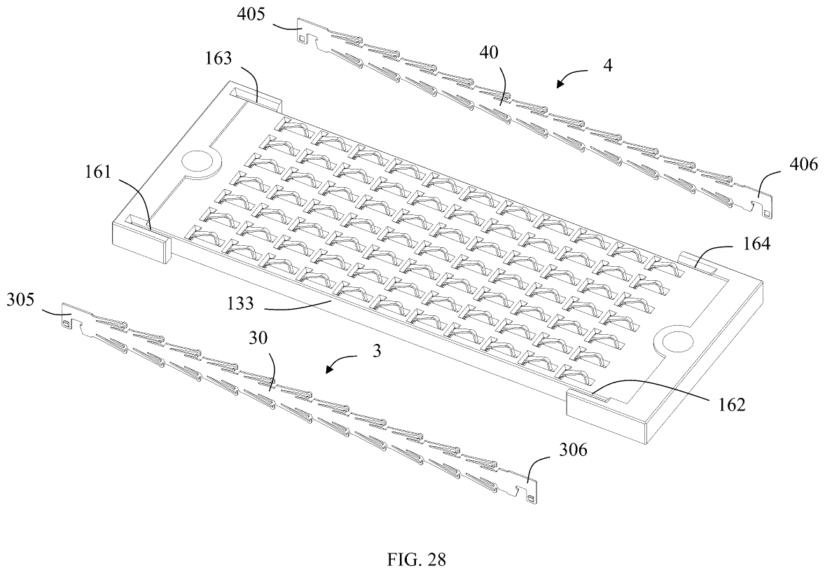

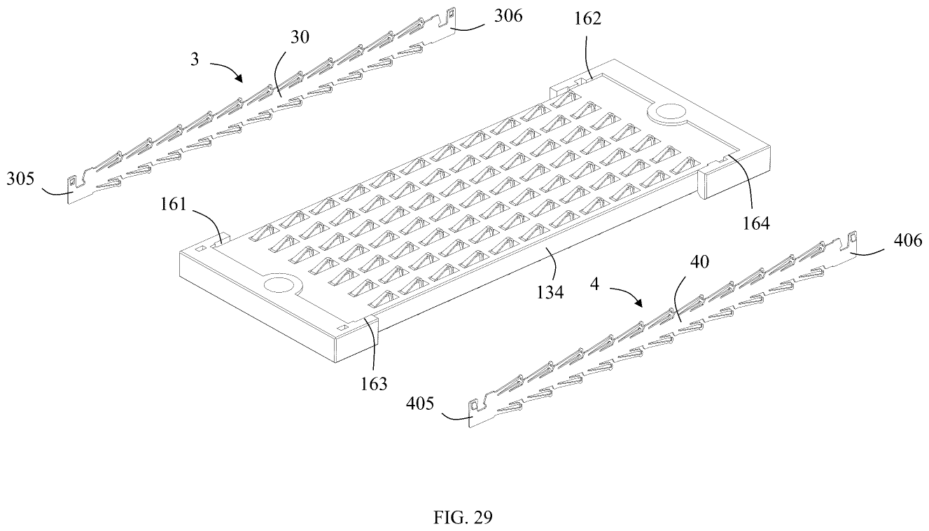

Referring to FIG. 1 to FIG. 29, the present disclosure discloses a board-to-board connector 100, which includes an insulating body 1, a plurality of conductive terminals 2 mounted to the insulating body 1, at least one first ground sheet 3 fixed to the insulating body 1, and at least one second ground sheet 4 fixed to the insulating body 1. The board-to-board connector 100 is configured to electrically connect a first circuit board 201 and a second circuit board 202 (as shown in FIG. 13).

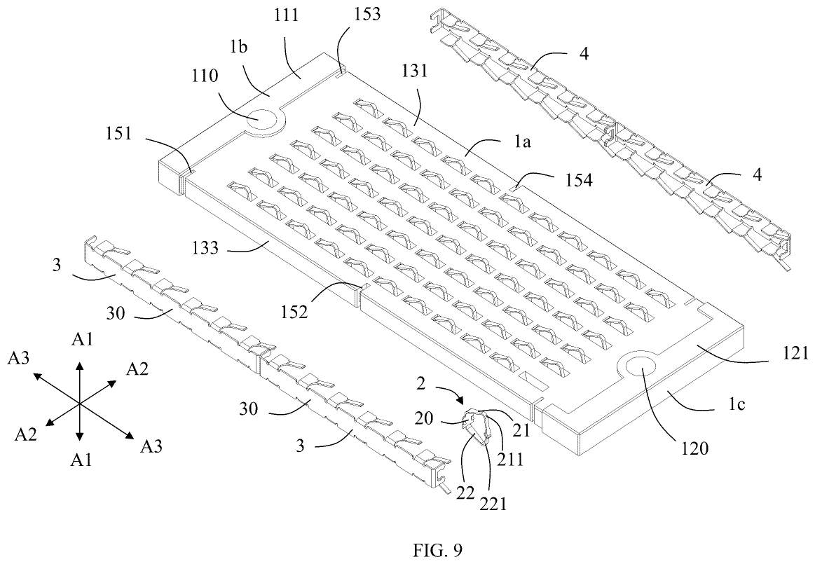

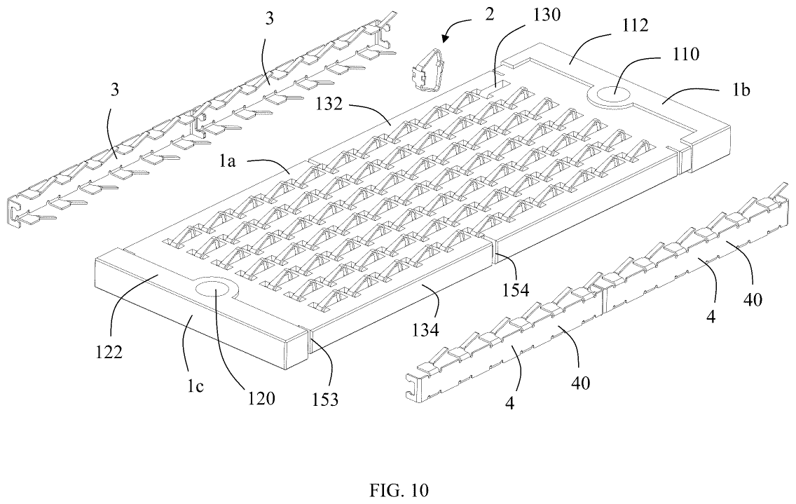

Referring to FIG. 9 and FIG. 10, in the illustrated embodiment of the present disclosure, the insulating body 1 includes a terminal installation area 1a, a first extension portion 1b connected to one side of the terminal installation area 1a, and a second extension portion 1c connected to another side of the terminal installation area 1a. In the illustrated embodiment of the present disclosure, the terminal installation area 1a, the first extension portion 1b and the second extension portion 1c are integrally formed.

In the illustrated embodiment of the present disclosure, the terminal installation area la includes a first surface 131 (for example, an upper surface), a second surface 132 (for example, a lower surface) opposite to the first surface 131 along a first direction A1-A1 (for example, a top-bottom direction), a plurality of terminal mounting grooves 130 extending through the first surface 131 and the second surface 132 along the first direction A1-A1, a first outer side surface 133, and a second outer side surface 134 opposite to the first outer side surface 133. In the illustrated embodiment of the present disclosure, the plurality of terminal mounting grooves 130 are disposed in a matrix along a second direction A2-A2 (for example, a left-right direction) and a third direction A3-A3 (for example, a front-rear direction). Each two of the first direction A1-A1, the second direction A2-A2 and the third direction A3-A3 are perpendicular to each other. In the first embodiment illustrated in the present disclosure, the first outer side surface 133 and the second outer side surface 134 are located at the outermost side of the terminal installation area 1a along the second direction A2-A2.

In the illustrated embodiment of the present disclosure, the first extension portion 1b and the second extension portion 1c are located at two ends of the terminal installation area la, respectively, along the third direction A3-A3. The first extension portion 1b and the second extension portion 1c both protrude upwardly and downwardly beyond the terminal installation area 1a along the first direction A1-A1.

Specifically, in the illustrated embodiment of the present disclosure, the first extension portion 1b includes a first upper surface 111, a first lower surface 112 opposite to the first upper surface 111 along the first direction A1-A1, and a first mounting hole 110 extending through the first upper surface 111 and the first lower surface 112 along the first direction A1-A1. The first upper surface 111 protrudes upwardly beyond the first surface 131. The first lower surface 112 protrudes downwardly beyond the second surface 132.

Similarly, in the illustrated embodiment of the present disclosure, the second extension portion 1c includes a second upper surface 121, a second lower surface 122 opposite to the second upper surface 121 along the first direction A1-A1, and a second mounting hole 120 extending through the second upper surface 121 and the second lower surface 122 along the first direction A1-A1. The second upper surface 121 protrudes upwardly beyond the first surface 131. The second lower surface 122 protrudes downwardly beyond the second surface 132. The first mounting hole 110 and the second mounting hole 120 are configured for fasteners (not shown) to pass through so as to fix the first circuit board 201, the board-to-board connector 100 and the second circuit board 202 together.

In the illustrated embodiment of the present disclosure, the first upper surface 111 of the first extension portion 1b and the second upper surface 121 of the second extension portion lc are coplanar to form a first mounting surface 11. The first lower surface 112 of the first extension portion 1b is coplanar with the second lower surface 122 of the second extension portion 1c to form a second mounting surface 12. The first mounting surface 11 and the second mounting surface 12 are configured to contact the first circuit board 201 and the second circuit board 202, respectively, when the first circuit board 201 and the second circuit board 202 are mounted with the board-to-board connector 100. It is understandable to those skilled in the art that by setting the first surface 131 of the terminal installation area 1a lower than the first mounting surface 11, that is, the first surface 131 is not in contact with the first circuit board 201, the coplanarity problem that may be caused by the large overall area of the first mounting surface 11 can be mitigated. Similarly, by setting the second surface 132 of the terminal installation area 1a higher than the second mounting surface 12, that is, the second surface 132 is not in contact with the second circuit board 202, the coplanarity problem that may be caused by the large overall area of the second mounting surface 12 can be mitigated.

Referring to FIG. 9, in the illustrated embodiment of the present disclosure, the plurality of conductive terminals 2 are arranged in a matrix. Each conductive terminal 2 includes a fixing portion 20 fixed in the terminal mounting groove 130, a first contact elastic arm 21 extending beyond the first mounting surface 11, and a second contact elastic arm 22 extending beyond the second mounting surface 12. The first contact elastic arm 21 includes a first contact surface 211 configured to abut against the first circuit board 201. The second contact elastic arm 22 includes a second contact surface 221 configured to abut against the second circuit board 202. In the illustrated embodiment of the present disclosure, both the first contact surface 211 and the second contact surface 221 are arc-shaped surfaces to reduce scratches with the circuit board.

In the illustrated embodiment of the present disclosure, the first ground sheet 3 and the second ground sheet 4 are both made of metal materials.

Referring to FIG. 1 to FIG. 14, in the first embodiment of the present disclosure, the first ground sheet 3 includes a first main body portion 30 covering at least part of the first outer side surface 133, a first bending portion 311 bent inwardly from a first end surface 301 (for example, an upper end surface) of the first main body portion 30, a first ground elastic arm 313 extending from the first bending portion 311, a second bending portion 312 bent inwardly from a second end surface 302 (for example, a lower end surface) of the first main body portion 30, a second ground elastic arm 314 extending from the second bending portion 312, a first fixing tab 315 bent inwardly from one end (for example, a front end) of the first main body portion 30, and a second fixing tab 316 bent inwardly from another end (for example, a rear end) of the first main body portion 30. The first ground elastic arm 313 and the second ground elastic arm 314 are extended from the first main body portion 30. In the illustrated embodiment of the present disclosure, the first ground elastic arm 313 and the second ground elastic arm 314 are both indirectly extended from the first main body portion 30. The first bending portion 311 is connected between the first ground elastic arm 313 and the first main body portion 30. The second bending portion 312 is connected between the second ground elastic arm 314 and the first main body portion 30. Of course, in other embodiments of the present disclosure, the first ground elastic arm 313 and the second ground elastic arm 314 can also be directly extended from the first main body portion 30. In the illustrated embodiment of the present disclosure, a plurality of first bending portions 311 are provided and are spaced apart along the third direction A3-A3. A plurality of second bending portions 312 are provided and are spaced apart along the third direction A3-A3. Correspondingly, a plurality of first ground elastic arms 313 are provided and are spaced apart along the third direction A3-A3. A plurality of second ground elastic arms 314 are provided and are spaced apart along the third direction A3-A3. In the first embodiment of the present disclosure, the first bending portion 311 is attached to and abuts against the first surface 131. The second bending portion 312 is attached to and abuts against the second surface 132.

In the illustrated embodiment of the present disclosure, the first ground elastic arm 313 is in a shape of a straight strip and extends obliquely. The first ground elastic arm 313 includes a first abutting portion 3131 located at a free end of the first ground elastic arm 313. The second ground elastic arm 314 is in a shape of a straight strip and extends obliquely. The second ground elastic arm 314 includes a second abutting portion 3141 located at a free end of the second ground elastic arm 314. The first abutting portion 3131 and the second abutting portion 3141 are configured to abut against ground pads on the first circuit board 201 and the second circuit board 202, respectively.

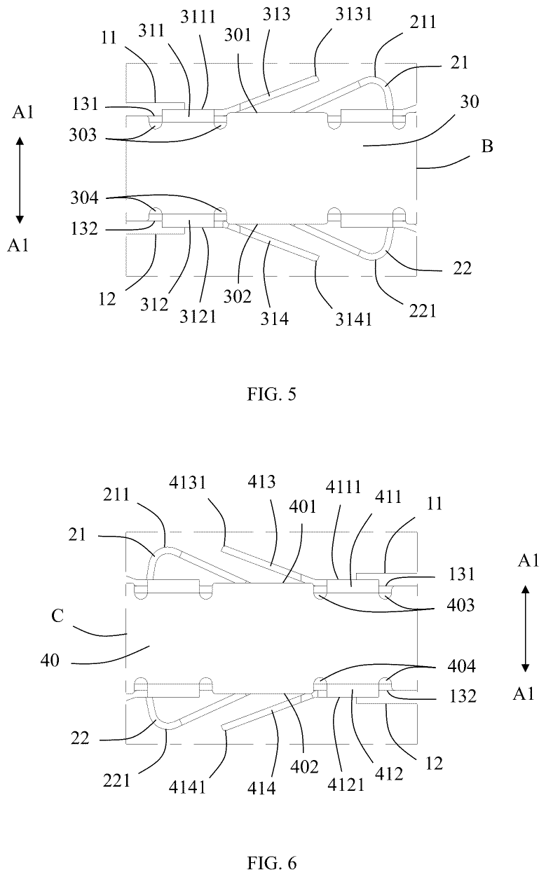

Referring to FIG. 5, in the illustrated embodiment of the present disclosure, the first end surface 301 is located between the first surface 131 and the first mounting surface 11 along the first direction A1-A1. The second end surface 302 is located between the second surface 132 and the second mounting surface 12 along the first direction A1-A1. With this arrangement, the first main body portion 30 of the first ground sheet 3 is able to cover as much of the first outer side surface 133 as possible in the first direction A1-A1, which is beneficial to improve the ground shielding effect.

Specifically, the first bending portion 311 includes an upper surface 3111 which is located between the first surface 131 and the first mounting surface 11 along the first direction A1-A1. The second bending portion 312 includes a lower surface 3121 which is located between the second surface 132 and the second mounting surface 12.

In the illustrated embodiment of the present disclosure, the first main body portion 30 includes two first notches 303 recessed from the first end surface 301 and two second notches 304 recessed from the second end surface 302. The first bending portion 311 is located between the two first notches 303. The second bending portion 312 is located between the two second notches 304. In this way, by providing the first notches 303 and the second notches 304, it is beneficial to reduce stress concentration when bending to form the first bending portion 311 and the second bending portion 312.

Referring to FIG. 1 to FIG. 14, in the first embodiment of the present disclosure, the second ground sheet 4 includes a second main body portion 40 covering at least part of the second outer side surface 134, a third bending portion 411 bent inwardly from a third end surface 401 (for example, an upper end surface) of the second main body portion 40, a third ground elastic arm 413 extending from the third bending portion 411, a fourth bending portion 412 bent inwardly from a fourth end surface 402 (for example, a lower end surface) of the second main body portion 40, a fourth ground elastic arm 414 extending from the fourth bending portion 412, a third fixing tab 415 bent inwardly from one end (for example, a front end) of the second main body portion 40 and a fourth fixing tab 416 bent inwardly from another end (for example, a rear end) of the second main body portion 40. In the illustrated embodiment of the present disclosure, a plurality of third bending portions 411 are provided and are spaced apart along the third direction A3-A3. A plurality of fourth bending portions 412 are provided and are spaced apart along the third direction A3-A3. Correspondingly, a plurality of third ground elastic arms 413 are provided and are spaced apart along the third direction A3-A3. A plurality of fourth ground elastic arms 414 are provided and are spaced apart along the third direction A3-A3. In the first embodiment of the present disclosure, the third bending portion 411 is attached to and abuts against the first surface 131. The fourth bending portion 412 is attached to and abuts against the second surface 132. In the illustrated embodiment of the present disclosure, the first ground elastic arm 313, the second ground elastic arm 314, the third ground elastic arm 413 and the fourth ground elastic arm 414 are disposed offset from the conductive terminals 2 in adjacent rows, respectively. Of course, it is understandable to those skilled in the art that the first ground elastic arm 313, the second ground elastic arm 314, the third ground elastic arm 413 and the fourth ground elastic arm 414 can also be adjusted to be aligned with the conductive terminals 2 in adjacent rows according to the layout of the circuit board, respectively, which is not limited by the present disclosure.

In the illustrated embodiment of the present disclosure, the third ground elastic arm 413 is in a shape of a straight strip and extends obliquely. The third ground elastic arm 413 is provided with a third abutting portion 4131 located at a free end of the third ground elastic arm 413. The fourth ground elastic arm 414 is in a shape of a straight strip and extends obliquely. The fourth ground elastic arm 414 is provided with a fourth abutting portion 4141 located at a free end of the fourth ground elastic arm 414. The third abutting portion 4131 and the fourth abutting portion 4141 are configured to abut against the ground pads on the first circuit board 201 and the second circuit board 202, respectively.

Referring to FIG. 6, in the illustrated embodiment of the present disclosure, the third end surface 401 is located between the first surface 131 and the first mounting surface 11 along the first direction A1-A1. The fourth end surface 402 is located between the second surface 132 and the second mounting surface 12 along the first direction A1-A1. With this arrangement, the second main body portion 40 of the second ground sheet 4 can cover as much of the second outer side surface 134 as possible in the first direction A1-A1, which is beneficial to improve the ground shielding effect.

Specifically, the third bending portion 411 includes an upper surface 4111 which is located between the third end surface 401 and the first mounting surface 11 along the first direction A1-A1. The fourth bending portion 412 includes a lower surface 4121 which is located between the fourth end surface 402 and the second mounting surface 12.

In the illustrated embodiment of the present disclosure, the second main body portion 40 includes two third notches 403 recessed from the third end surface 401 and two fourth notches 404 recessed from the fourth end surface 402. The third bending portion 411 is located between the two third notches 403. The fourth bending portion 412 is located between the two fourth notches 404. In this way, by providing the third notches 403 and the fourth notches 404, it is beneficial to reduce stress concentration when bending to form the third bending portion 411 and the fourth bending portion 412.

As shown in FIG. 9, in the illustrated embodiment of the present disclosure, the insulating body 1 defines a first fixing groove 151 extending inwardly from the first outer side surface 133 and a second fixing groove 152 extending inwardly from the first outer side surface 133. The first fixing tab 315 is inserted into and fixed in the first fixing groove 151. The second fixing tab 316 is inserted into and fixed in the second fixing groove 152.

In the first illustrated embodiment of the present disclosure, a plurality of (for example, two) first ground sheets 3 are provided. In any two adjacent first ground sheets 3, the second fixing tab 316 of one of the first ground sheets 3 and the first fixing tab 315 of a remaining one of the first ground sheets 3 are in contact with each other (for example, attached to each other). With this arrangement, all the first ground sheets 3 are connected in series to form a whole, so as to improve the ground shielding effect.

Similarly, as shown in FIG. 10, in the illustrated embodiment of the present disclosure, the insulating body 1 defines a third fixing groove 153 extending inwardly from the second outer side surface 134 and a fourth fixing groove 154 extending inwardly from the second outer side surface 134. The third fixing tab 415 is inserted into and fixed in the third fixing groove 153. The fourth fixing tab 416 is inserted into and fixed in the fourth fixing groove 154.

In the first illustrated embodiment of the present disclosure, a plurality of (for example, two) second ground sheets 4 are provided. In any two adjacent second ground sheets 4, the fourth fixing tab 416 of one of the second ground sheets 4 and the third fixing tab 415 of a remaining one of the second ground sheets 4 are in contact with each other (for example, attached to each other). With this arrangement, all the second ground sheets 4 are connected in series to form a whole, so as to improve the ground shielding effect.

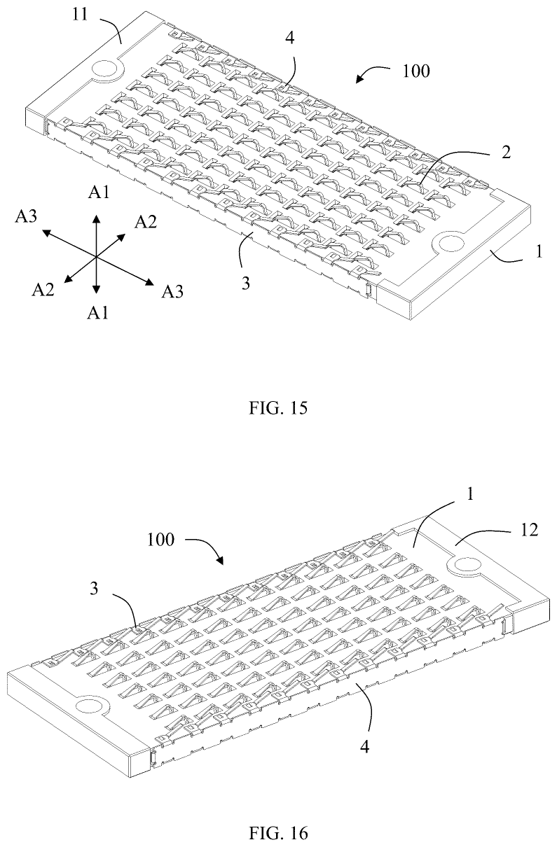

As shown in FIG. 15 to FIG. 18, the board-to-board connector 100 in the second embodiment of the present disclosure is similar to the board-to-board connector 100 in the first embodiment of the present disclosure, where the same reference numbers indicate the same or corresponding technical features. Only the main differences between the first embodiment and the second embodiment will be described below.

In the board-to-board connector 100 of the second embodiment of the present disclosure, each of the first ground sheet 3 and the second ground sheet 4 is of an integrated structure. In other words, the first ground sheet 3 and the second ground sheet 4 are integrated of one piece, respectively. It is understandable to those skilled in the art that the integrated first ground sheet 3 itself has a longer size than the two-part first ground sheet 3. Especially when the first ground sheet 3 is elongated, the integrated first ground sheet 3 is more likely to deform, which may result in insufficient adhesion between the first ground sheet 3 and the first outer side surface 133. In order to solve this problem, in the board-to-board connector 100 of the second embodiment of the present disclosure, the terminal installation area 1a includes a plurality of first fixing holes 1311 recessed downwardly from the first surface 131 and a plurality of second fixing holes 1321 recessed upwardly from the second surface 132. The first bending portion 311 is provided with a first holding tab 311a that is held in a corresponding first fixing hole 1311. The second bending portion 312 is provided with a second holding tab 312a that is held in a corresponding second fixing hole 1321. Preferably, the first holding tab 311a is integrally stamped from the first bending portion 311. The second holding tab 312a is integrally stamped from the second bending portion 312.

In the board-to-board connector 100 of the second embodiment of the present disclosure, the first fixing holes 1311 are only slightly recessed downwardly and do not extend through the second surface 132 so as to minimize the impact on the structural strength of the insulating body 1. The second fixing holes 1321 are only slightly recessed upwardly and do not extend through the first surface 131 so as to minimize the impact on the structural strength of the insulating body 1.

It is understandable to those skilled in the art that the integrated second ground sheet 4 itself has a longer size than the two-part second ground sheet 4. Especially when the second ground sheet 4 is elongated, the integrated second ground sheet 4 is more likely to be deformed, which may result in insufficient adhesion between the second ground sheet 3 and the second outer side surface 134. In order to solve this problem, in the board-to-board connector 100 of the second embodiment of the present disclosure, the terminal installation area 1a includes a plurality of third fixing holes 1312 recessed downwardly from the first surface 131 and a plurality of fourth fixing holes 1322 recessed upwardly from the second surface 132. The third bending portion 411 is provided with a third holding tab 411a that is held in a corresponding third fixing hole 1312. The fourth bending portion 412 is provided with a fourth holding tab 412a that is held in a corresponding fourth fixing hole 1322. Preferably, the third holding tab 411a is integrally stamped from the third bending portion 411. The fourth holding tab 412a is integrally stamped from the fourth bending portion 412.

In the board-to-board connector 100 of the second embodiment of the present disclosure, the third fixing holes 1312 are only slightly recessed downwardly and do not extend through the second surface 132 so as to minimize the impact on the structural strength of the insulating body 1. The fourth fixing holes 1322 are only slightly recessed upwardly and do not extend through the first surface 131 so as to minimize the impact on the structural strength of the insulating body 1.

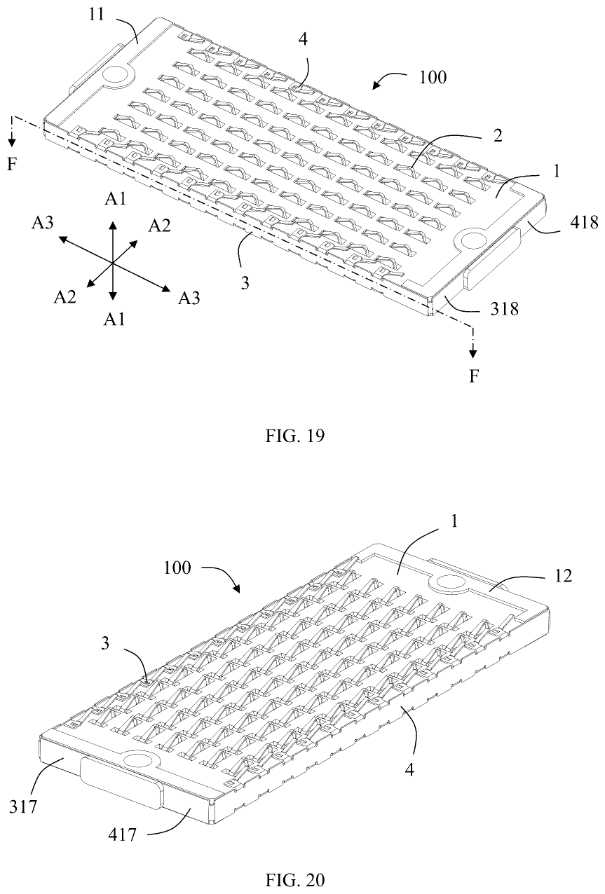

As shown in FIG. 19 to FIG. 23, the board-to-board connector 100 in the third embodiment of the present disclosure is similar to the board-to-board connector 100 in the second embodiment of the present disclosure, where the same reference numbers indicate the same or corresponding technical features. Only the main differences between the second embodiment and the third embodiment will be described below.

In the board-to-board connector 100 of the third embodiment of the present disclosure, each of the first ground sheet 3 and the second ground sheet 4 is of an integrated structure. The first ground sheet 3 includes a first fixing portion 317 bent from one end of the first main body portion 30 and a second fixing portion 318 bent from another end of the first main body portion 30. Similarly, the second ground sheet 4 is of an integrated structure. The second ground sheet 4 includes a third fixing portion 417 bent from one end of the second main body portion 40 and a fourth fixing portion 418 bent from another end of the second main body portion 40.

The insulating body 1 includes a third outer side surface 135 and a fourth outer side surface 136 is opposite to the third outer side surface 135 along the third direction A3-A3. Both the first fixing portion 317 and the third fixing portion 417 at least partially cover the third outer side surface 135. Both the second fixing portion 318 and the fourth fixing portion 418 at least partially cover the fourth outer side surface 136. With this arrangement, the ground shielding effect can be further improved by providing the first fixing portion 317, the second fixing portion 318, the third fixing portion 417 and the fourth fixing portion 418.

In the third embodiment illustrated in the present disclosure, after the first ground sheet 3 and the second ground sheet 4 are fixed to the insulating body 1, the first fixing portion 317 and the third fixing portion 417 are in contact with each other, and the second fixing portion 318 and the fourth fixing portion 418 are in contact with each other. Therefore, the first ground sheet 3 and the second ground sheet 4 are connected as a whole, which further improves the ground shielding effect.

Specifically, in the third embodiment illustrated in the present disclosure, the insulating body 1 includes a first protrusion 137 protruding beyond the third outer side surface 135 and a second protrusion 138 protruding beyond the fourth outer side surface 136. The first protrusion 137 includes a first holding block 1371, a second holding block 1372, and a first locking groove 1370 located between the first holding block 1371 and the second holding block 1372 along the second direction A2-A2. The second protrusion 138 includes a third holding block 1381, a fourth holding block 1382, and a second locking groove 1380 located between the third holding block 1381 and the fourth holding block 1382 along the second direction A2-A2.

The first fixing portion 317 includes two first clamping arms 3171 and a first clamping groove 3172 located between the two first clamping arms 3171. The first holding block 1371 is received in the first clamping groove 3172. Each first clamping arm 3171 is provided with a first hook portion 3173 protruding into the first locking groove 1370.

The third fixing portion 417 includes two third clamping arms 4171 and a third clamping groove 4172 located between the two third clamping arms 4171. The second holding block 1372 is received in the third clamping groove 4172. Each third clamping arm 4171 is provided with a third hook portion 4173 protruding into the first locking groove 1370.

Similarly, the second fixing portion 318 includes two second clamping arms 3181 and a second clamping groove 3182 located between the two second clamping arms 3181. The third holding block 1381 is received in the second clamping groove 3182. Each second clamping arm 3181 is provided with a second hook portion 3183 protruding into the second locking groove 1380.

The fourth fixing portion 418 includes two fourth clamping arms 4181 and a fourth clamping groove 4182 located between the two fourth clamping arms 4181. The fourth holding block 1382 is received in the fourth clamping groove 4182. Each fourth clamping arm 4181 is provided with a fourth hook portion 4183 protruding into the second locking groove 1380.

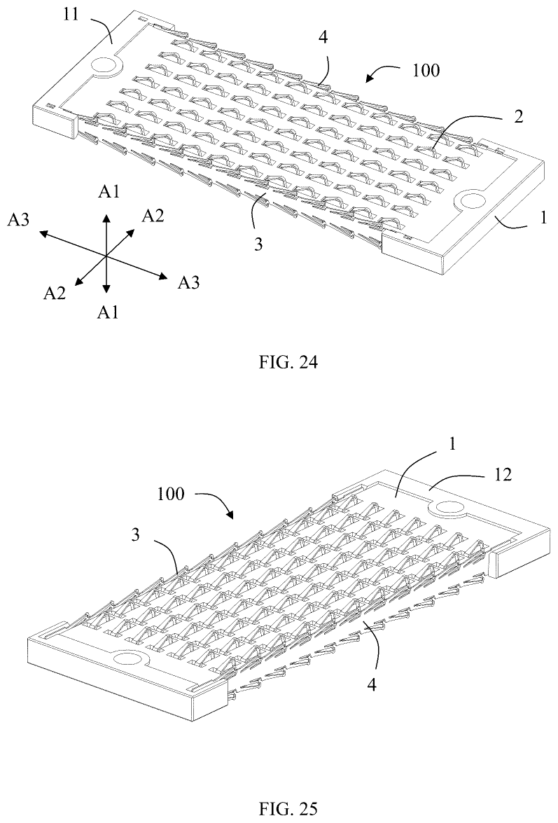

As shown in FIG. 24 to FIG. 29, the board-to-board connector 100 in the fourth embodiment of the present disclosure is similar to the board-to-board connector 100 in the first embodiment of the present disclosure, where the same reference numbers indicate the same or corresponding technical features. Only the main differences between the first embodiment and the fourth embodiment will be described below.

In the board-to-board connector 100 of the fourth embodiment of the present disclosure, each of the first ground sheet 3 and the second ground sheet 4 is of an integrated structure and is made by blanking. The first ground sheet 3 further includes a plurality of cantilever-shaped first abutting arms 3191 that cooperate with the first ground elastic arms 313 and a plurality of cantilever-shaped second abutting arms 3192 that cooperate with the second ground elastic arms 314.

When the first abutting portion 3131 of the first ground elastic arm 313 is in position with the first circuit board 201, the first ground elastic arm 313 elastically deforms downwardly so as to contact (for example, overlap) the first abutting arm 3191. The first ground elastic arm 313 contacts the first abutting arm 3191 to generate a secondary ground loop, thereby improving the high-frequency characteristics of the board-to-board connector 100.

Similarly, when the second abutting portion 3141 of the second ground elastic arm 314 is in position with the second circuit board 202, the second ground elastic arm 314 elastically deforms upward, so as to contact (for example, overlap) the second abutting arm 3192. The second ground elastic arm 314 contacts the second abutting arm 3192 to generate a secondary ground loop, thereby improving the high-frequency characteristics of the board-to-board connector 100.

In the board-to-board connector 100 of the fourth embodiment of the present disclosure, the first ground sheet 3 includes a first main body portion 30 covering at least part of the first outer side surface 133, a first holding portion 305 extending from one end of the first main body portion 30, and a second holding portion 306 extending from another end of the first main body portion 30. The insulating body 1 defines a first holding groove 161 for fixing the first holding portion 305 and a second holding groove 162 for fixing the second holding portion 306.

Similarly, the second ground sheet 4 further includes a plurality of cantilever-shaped third abutting arms 4191 that cooperate with the third ground elastic arms 413 and a plurality of cantilever-shaped fourth abutting arms 4192 that cooperate with the fourth ground elastic arms 414.

When the third abutting portion 4131 of the third ground elastic arm 413 is in position with the first circuit board 201, the third ground elastic arm 413 elastically deforms downwardly so as to contact (for example, overlap) the third abutting arm 4191. The third ground elastic arm 413 contacts the third abutting arm 4191 to generate a secondary ground loop, thereby improving the high-frequency characteristics of the board-to-board connector 100.

When the fourth abutting portion 4141 of the fourth ground elastic arm 414 is in position with the second circuit board 202, the fourth ground elastic arm 414 elastically deforms upwardly so as to contact (for example, overlap) the fourth abutting arm 4192. The fourth ground elastic arm 414 contacts the fourth abutting arm 4192 to generate a secondary ground loop, thereby improving the high-frequency characteristics of the board-to-board connector 100.

Similarly, in the board-to-board connector 100 of the fourth embodiment of the present disclosure, the second ground sheet 4 includes a second main body portion 40 covering at least part of the second outer side surface 134, a third holding portion 405 extending from one end of the second main body portion 40, and a fourth holding portion 406 extending from another end of the second main body portion 40. The insulating body 1 defines a third holding groove 163 for fixing the third holding portion 405 and a fourth holding groove 164 for fixing the fourth holding portion 406.

It is understandable to those skilled in the art that compared with the first ground sheet 3 and the second ground sheet 4 in the first to third embodiments, in the fourth embodiment of the present disclosure, the first ground sheet 3 and the second ground sheet 4 are made by blanking. The first ground elastic arm 313, the second ground elastic arm 314, the third ground elastic arm 413 and the fourth ground elastic arm 414 have good structural strength, but their elastic deformation ability is slightly weak. It is understandable to those skilled in the art that the structural design of the first ground elastic arm 313, the second ground elastic arm 314, the third ground elastic arm 413 and the fourth ground elastic arm 414 can be flexibly adjusted according to actual needs, which will not be limited by the present disclosure.

Compared with the prior art, the terminal installation area 1a of the present disclosure includes the first outer side surface 133. The board-to-board connector 100 includes the first ground sheet 3. The first ground sheet 3 is fixed to the insulating body 1. The first ground sheet 3 includes the first main body portion 30 covering at least part of the first outer side surface 133, the first ground elastic arm 313 extending beyond the first mounting surface 11, and the second ground elastic arm 314 extending beyond the second mounting surface 12. With this configuration, the board-to-board connector 100 of the present disclosure can achieve a ground shielding function. Besides, the insulating housing 1 of the present disclosure does not form any slot which is located between two adjacent rows of conductive terminals 2 (i.e., inside the insulating housing 1), extends through the insulating body 1 along the first direction A1-A1, and is configured to install the first ground sheet 3. As a result, this minimizes damage to the structural strength of the insulating body 1 and is suitable for thin board-to-board connectors 100. It is understandable to those skilled in the art that the slot is a long through hole with a length greater than four times the thickness of the insulating body 1 along the first direction A1-A1. The design of such long through hole can easily significantly weaken the structural strength of the insulating body 1.

The terminal installation area 1a of the present disclosure includes the second outer side surface 134. The board-to-board connector 100 includes the second ground sheet 4. The second ground sheet 4 is fixed to the insulating body 1. The second ground sheet 4 includes a second main body portion 40 covering at least part of the second outer side surface 134, the third ground elastic arm 413 extending beyond the first mounting surface 11, and the fourth ground elastic arm 414 extending beyond the second mounting surface 12. With this configuration, the board-to-board connector 100 of the present disclosure can achieve a ground shielding function. Besides, the insulating housing 1 of the present disclosure does not form any slot which is located between two adjacent rows of conductive terminals 2 (i.e., inside the insulating housing 1), extends through the insulating housing 1 along the first direction A1-A1, and is configured to install the second ground sheet 4. As a result, this minimizes damage to the structural strength of the insulating body 1 and is suitable for thin board-to-board connectors 100.

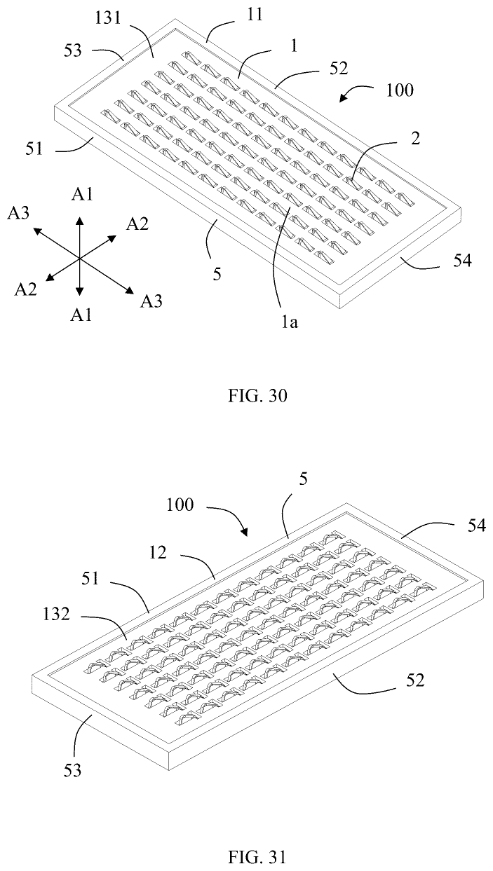

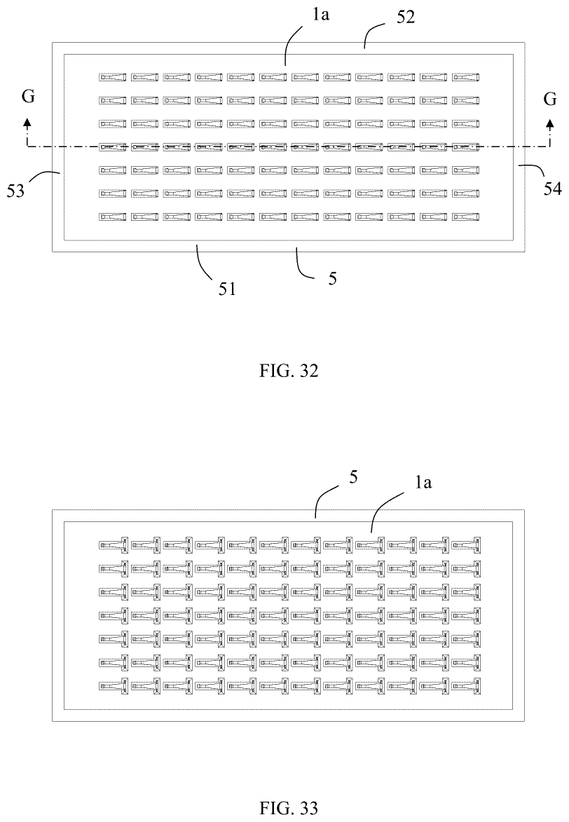

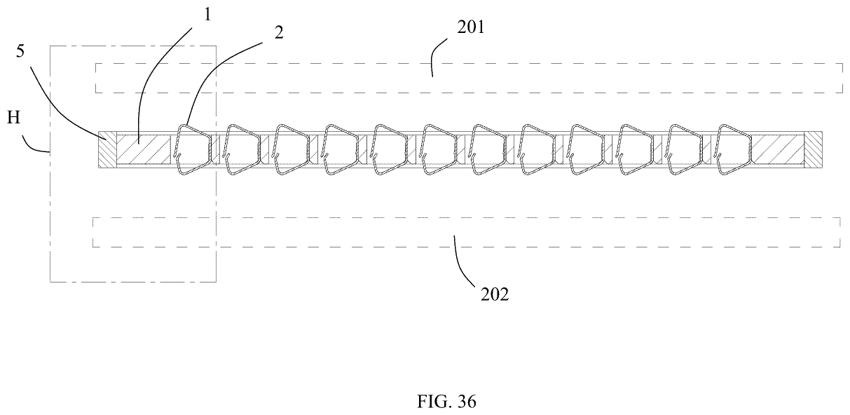

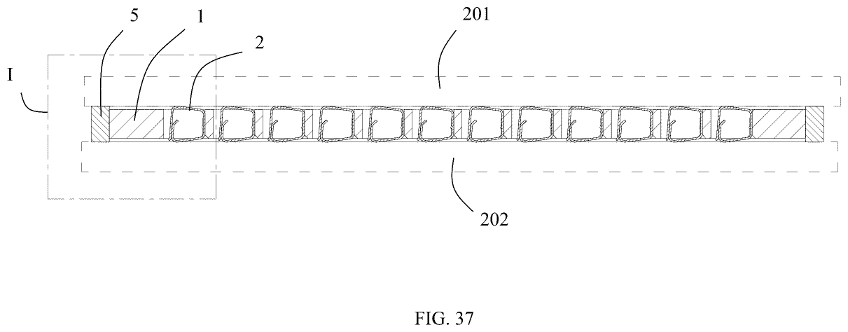

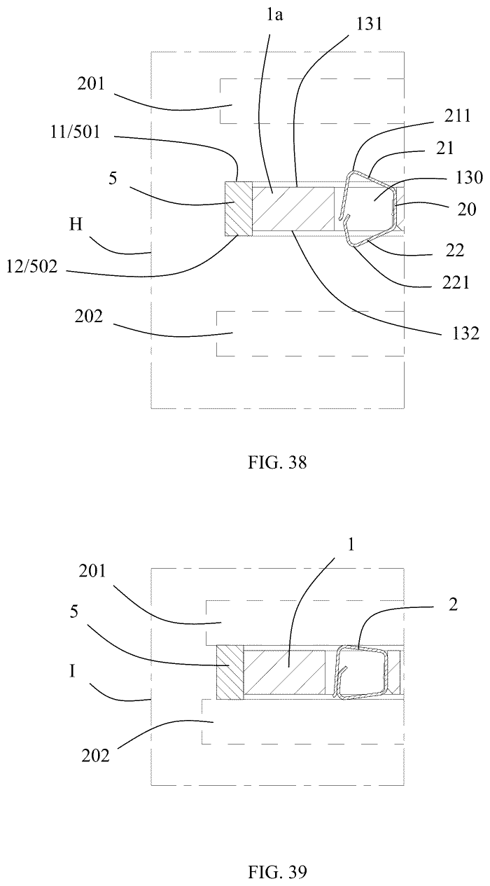

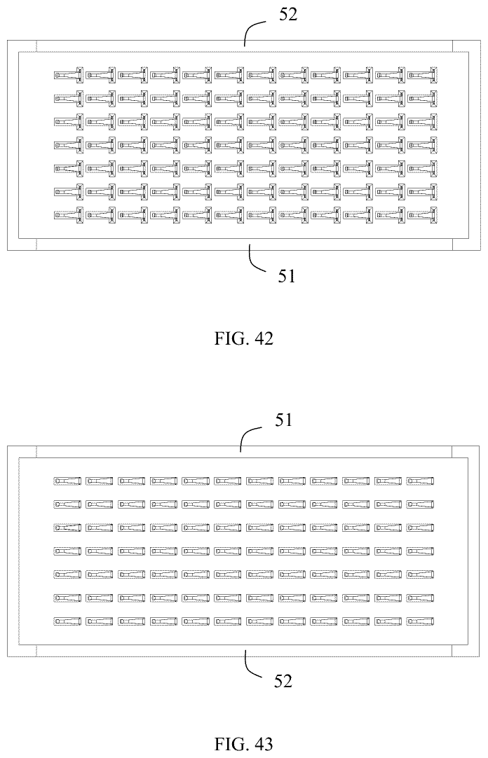

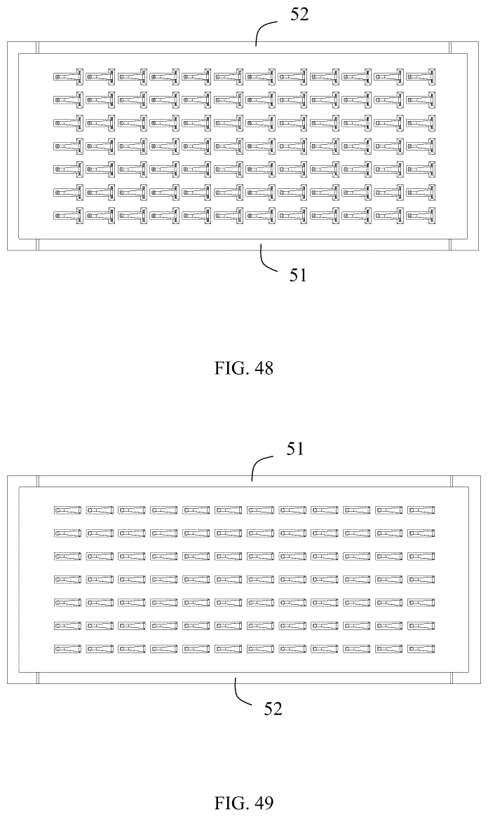

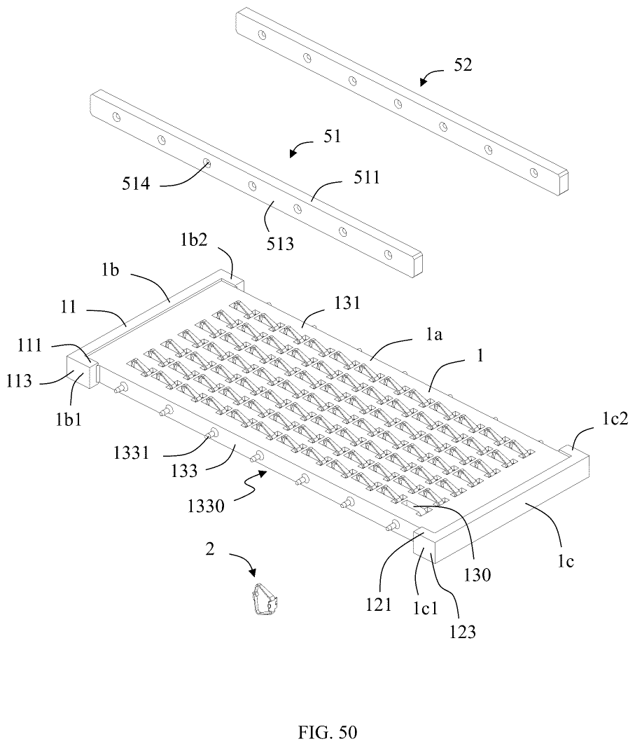

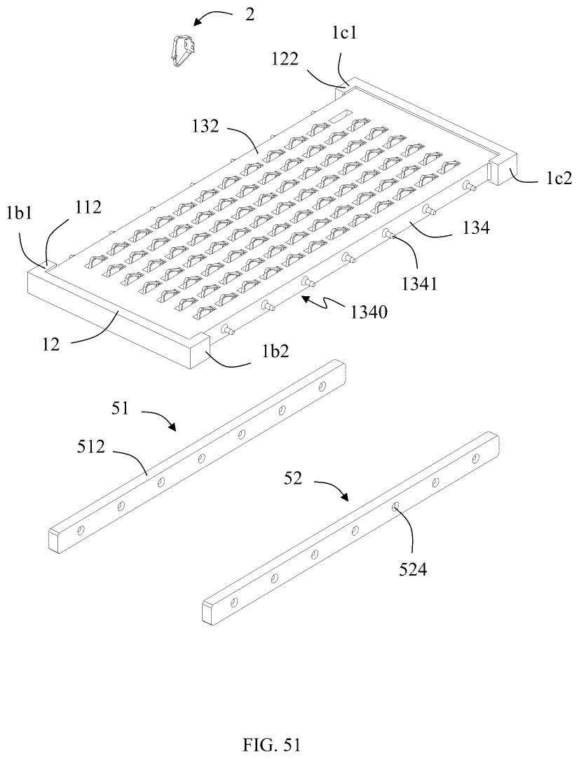

Referring to FIG. 30 to FIG. 51, the present disclosure discloses another board-to-board connector 100, which includes an insulating body 1, a plurality of conductive terminals 2 mounted to the insulating body 1, and a wave-absorbing material 5. The board-to-board connector 100 is configured to electrically connect a first circuit board 201 and a second circuit board 202 (as shown in FIG. 36 and FIG. 37). In an embodiment of the present disclosure, the wave-absorbing material 5 is fixed to the insulating body 1 through injection molding. In an embodiment of the present disclosure, the conductivity of the material of the wave-absorbing material 5 is 20 S·m⁻¹. In one embodiment of the present disclosure, the wave-absorbing material 5 is made of plastic and contains conductive particles such as metal and stone grinding. The dielectric loss through the conductive path reaches a low conductivity to absorb and attenuate the electromagnetic wave energy incident in space. The metal has an electrical conductivity of 10⁶S·m⁻¹. It is understandable to those of ordinary skill in the art that designers can adjust the wave absorption capacity and frequency band to be absorbed according to the structural size and the conductivity material which is much lower than that of the metal. The types of materials of the wave-absorbing material 5 include but are not limited thereto.

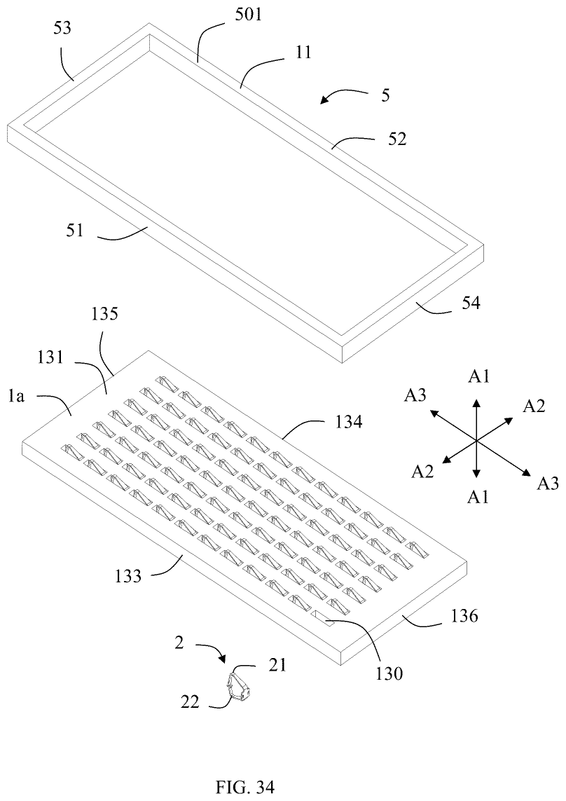

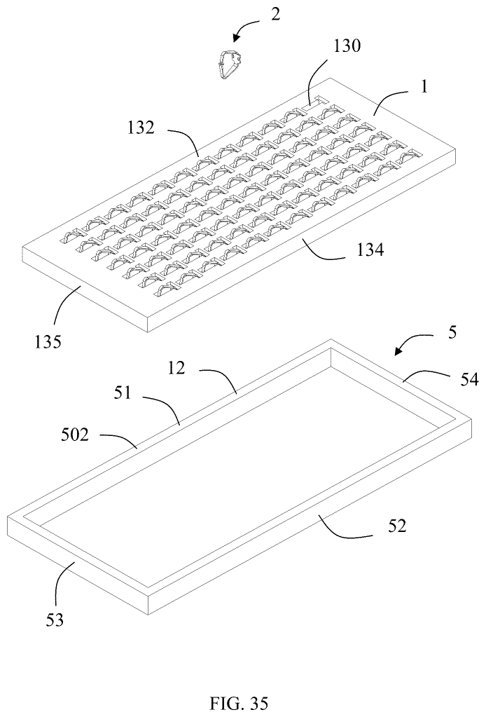

Referring to FIG. 34 and FIG. 35, in the illustrated embodiment of the present disclosure, the insulating body 1 includes a terminal installation area 1a. In the illustrated embodiment of the present disclosure, the terminal installation area 1a is substantially rectangular parallelepiped-shaped. The terminal installation area 1a includes a first surface 131 (for example, an upper surface), a second surface 132 (for example, a lower surface) opposite to the first surface 131 along a first direction A1-A1 (for example, a top-bottom direction), a plurality of terminal mounting grooves 130 extending through the first surface 131 and the second surface 132 along the first direction A1-A1, a first outer side surface 133, a second outer side surface 134, a third outer side surface 135 and a fourth outer side surface 136. The second outer side surface 134 is disposed opposite to the first outer side surface 133 along a second direction A2-A2. The fourth outer side surface 136 is disposed opposite to the third outer side surface 135 along a third direction A3-A3. Each two of the first direction A1-A1, the second direction A2-A2 and the third direction A3-A3 are perpendicular to each other.

In the fifth embodiment illustrated in the present disclosure, the wave-absorbing material 5 is in of a frame-shaped configuration, so as to achieve a better noise absorption effect. The wave-absorbing material 5 includes a first wave-absorbing plate portion 51 covering at least part of the first outer side surface 133, a second wave-absorbing plate portion 52 covering at least part of the second outer side surface 134, a third wave-absorbing plate portion 53 covering at least part of the third outer side surface 135, and a fourth wave-absorbing plate portion 54 covering at least part of the fourth outer side surface 136. The first wave-absorbing plate portion 51 is disposed adjacent to a ground portion of the first circuit board 201 and/or adjacent to a ground portion of the second circuit board 202. The first wave-absorbing plate portion 51 may be disposed in contact with the ground portion of the first circuit board 201 and/or the ground portion of the second circuit board 202. Alternatively, the first wave-absorbing plate portion 51 may be spaced a certain distance from the ground portion of the first circuit board 201 and/or the second circuit board 202. The second wave-absorbing plate portion 52 is disposed adjacent to the ground portion of the first circuit board 201 and/or adjacent to the ground portion of the second circuit board 202. The second wave-absorbing plate portion 52 may be disposed in contact with the ground portion of the first circuit board 201 and/or the second circuit board 202. Alternatively, the second wave-absorbing plate portion 52 may be spaced a certain distance from the ground portion of the first circuit board 201 and/or the second circuit board 202. The third wave-absorbing plate portion 53 is disposed adjacent to the ground portion of the first circuit board 201 and/or adjacent to the ground portion of the second circuit board 202. The third wave-absorbing plate portion 53 may be disposed in contact with the ground portion of the first circuit board 201 and/or the ground portion of the second circuit board 202. Alternatively, the third wave-absorbing plate portion 53 may be spaced a certain distance away from the ground portion of the first circuit board 201 and/or the ground portion of the second circuit board 202. The fourth wave-absorbing plate portion 54 is disposed adjacent to the ground portion of the first circuit board 201 and/or adjacent to the ground portion of the second circuit board 202. The fourth wave-absorbing plate portion 54 may be disposed in contact with the ground portion of the first circuit board 201 and/or the ground portion of the second circuit board 202. Alternatively, the fourth wave-absorbing plate portion 54 may be spaced a certain distance from the ground portion of the first circuit board 201 and/or the ground portion of the second circuit board 202. It is understandable to those skilled in the art that the ground portion of the first circuit board 201 and/or the ground portion of the second circuit board 202 may be a ground layer or a ground pad, which will not be described in detail in the present disclosure.

Referring to FIG. 30 to FIG. 39, in the fifth embodiment of the present disclosure, the wave-absorbing material 5 is provided with a flat upper surface 501 and a flat lower surface 502. The upper surface 501 of the wave-absorbing material 5 forms the first mounting surface 11. The first mounting surface 11 is configured to mount the first circuit board 201. The lower surface 502 of the wave-absorbing material 5 forms the second mounting surface 12. The second mounting surface 12 is configured to mount the second circuit board 202. The first mounting surface 11 protrudes upwardly beyond the first surface 131 of the terminal installation area 1a. The second mounting surface 12 protrudes downwardly beyond the second surface 132 of the terminal installation area 1a. It is understandable to those skilled in the art that by setting the first surface 131 of the terminal installation area 1a lower than the first mounting surface 11, that is, the first surface 131 is not in contact with the first circuit board 201, the coplanarity problem that may be caused by the large overall area of the first mounting surface 11 can be mitigated. Similarly, by setting the second surface 132 of the terminal installation area 1a higher than the second mounting surface 12, that is, the second surface 132 is not in contact with the second circuit board 202, the coplanarity problem that may be caused by the large overall area of the second mounting surface 12 can be mitigated.

In the illustrated embodiment of the present disclosure, the plurality of conductive terminals 2 are arranged in a matrix. Each conductive terminal 2 includes a fixing portion 20 fixed in the terminal mounting groove 130, a first contact elastic arm 21 extending beyond the first mounting surface 11, and a second contact elastic arm 22 extending beyond the second mounting surface 12. The first contact elastic arm 21 includes a first contact surface 211 configured to abut against the first circuit board 201. The second contact elastic arm 22 includes a second contact surface 221 configured to abut against the second circuit board 202. In the illustrated embodiment of the present disclosure, both the first contact surface 211 and the second contact surface 221 are arc-shaped surfaces to reduce scratches with the circuit board.

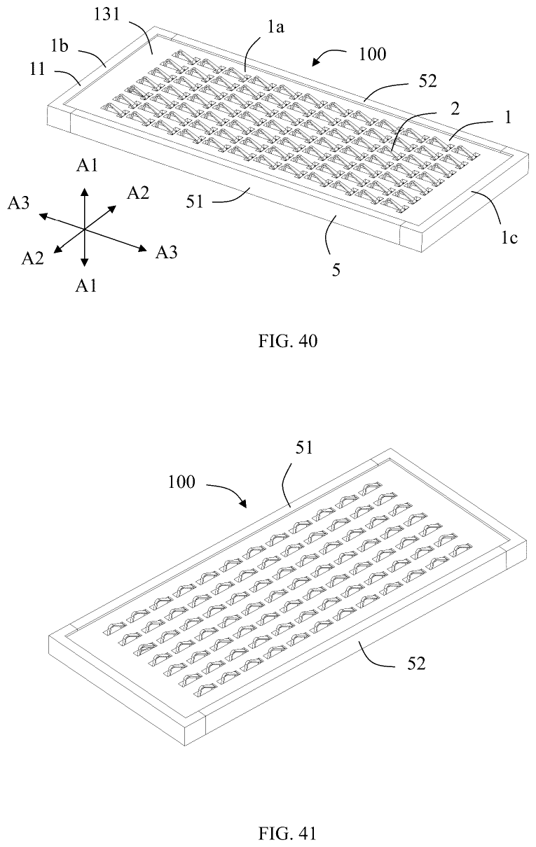

As shown in FIG. 40 to FIG. 45, the board-to-board connector 100 in the sixth embodiment of the present disclosure is substantially the same as the board-to-board connector 100 in the fifth embodiment of the present disclosure, wherein the same reference numbers indicate the same or corresponding technical features. Only the main differences between the two are described below.

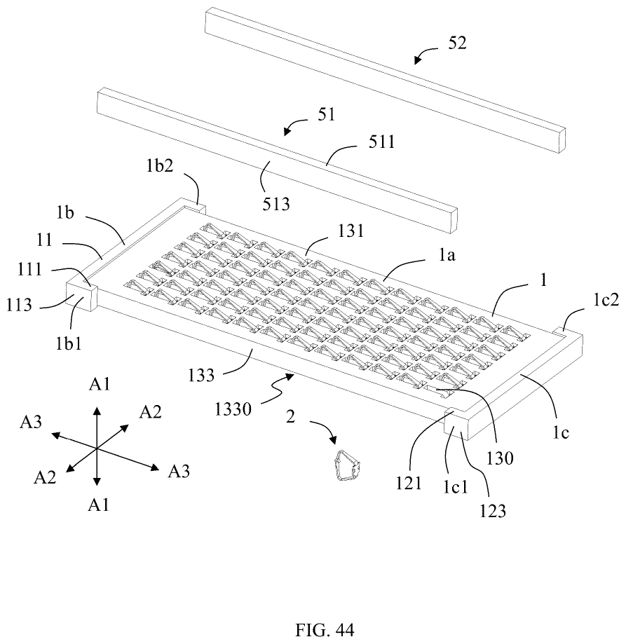

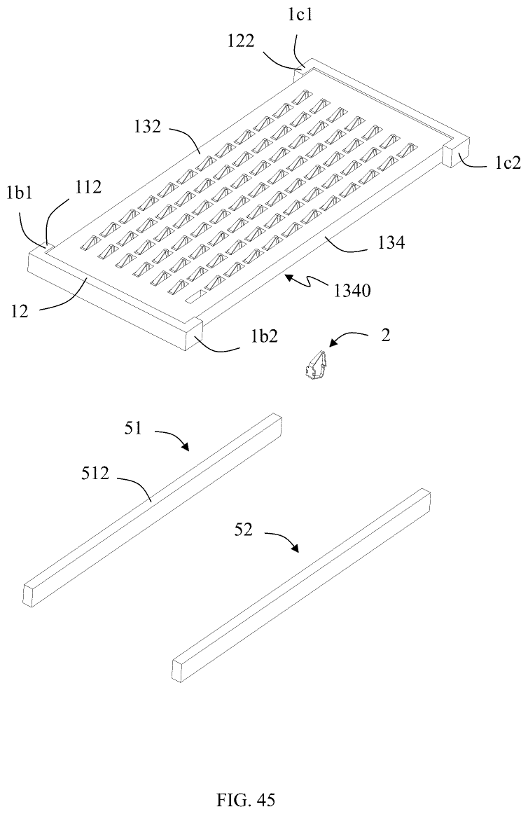

Referring to FIG. 44 and FIG. 45, in the sixth embodiment of the present disclosure, the insulating body 1 includes a terminal installation area 1a, a first extension portion 1b connected to one side of the terminal installation area 1a, and a second extension portion 1c connected to the other side of the terminal installation area 1a. In the illustrated embodiment of the disclosure, the terminal installation area 1a, the first extension portion 1b and the second extension portion 1c are integrally formed.

In the illustrated embodiment of the present disclosure, the terminal installation area la includes a first surface 131 (for example, an upper surface), a second surface 132 (for example, a lower surface) opposite to the first surface 131 along a first direction A1-A1 (for example, a top-bottom direction), a plurality of terminal mounting grooves 130 extending through the first surface 131 and the second surface 132 along the first direction A1-A1, a first outer side surface 133, and a second outer side surface 134 opposite to the first outer side surface 133. In the illustrated embodiment of the present disclosure, the plurality of terminal mounting grooves 130 are disposed in a matrix along a second direction A2-A2 (for example, a left-right direction) and a third direction A3-A3 (for example, a front-rear direction). Each two of the first direction A1-A1, the second direction A2-A2 and the third direction A3-A3 are perpendicular to each other. In the fifth embodiment illustrated in the present disclosure, the first outer side surface 133 and the second outer side surface 134 are located at the outermost side of the terminal installation area 1a along the second direction A2-A2.

The wave-absorbing material 5 includes a first wave-absorbing plate portion 51 covering at least part of the first outer side surface 133 and a second wave-absorbing plate portion 52 covering at least part of the second outer side surface 134. The first wave-absorbing plate portion 51 and the second wave-absorbing plate portion 52 are two parts provided separately.

In the sixth embodiment illustrated in the present disclosure, the first extension portion 1b and the second extension portion 1c are disposed adjacent to two ends of the terminal installation area 1a, respectively, along the third direction A3-A3. The first extension portion 1b and the second extension portion 1c both protrude upwardly and downwardly beyond the terminal installation area 1a along the first direction A1-A1.

Referring to FIG. 44 and FIG. 45, in the sixth embodiment of the present disclosure, the first extension portion 1b includes a first extension protrusion 1b1. The second extension portion 1c includes a second extension protrusion 1c1. The insulating body 1 includes a first receiving space 1330 located between the first extension protrusion 1b1 and the second extension protrusion 1c1. The first wave-absorbing plate portion 51 is received in the first receiving space 1330.

The first extension protrusion 1b1 is provided with a first upper surface 111 and a first lower surface 112 opposite to the first upper surface 111 along the first direction A1-A1. The second extension protrusion 1c1 is provided with a second upper surface 121 and a second lower surface 122 opposite to the second upper surface 121 along the first direction A1-A1. The first wave-absorbing plate portion 51 includes a first top surface 511 and a first bottom surface 512 opposite to the first top surface 511 along the first direction A1-A1. The first upper surface 111 and the second upper surface 121 are flush with each other so as to form the first mounting surface 11. The first mounting surface 11 is configured to mount the first circuit board 201. The first top surface 511 is flush with the first mounting surface 11 to reduce gaps through which noise can leak. The first lower surface 112 and the second lower surface 122 are flush with each other so as to form the second mounting surface 12. The second mounting surface 12 is configured to mount the second circuit board 202. The first bottom surface 512 is flush with the second mounting surface 12 to reduce gaps through which noise can leak.

Besides, the first extension protrusion 1b1 is provided with a first outer surface 113. The second extension protrusion 1c1 is provided with a second outer surface 123. The first wave-absorbing plate portion 51 includes a first outer side surface 513. The first outer surface 113, the second outer surface 123 and the first outer side surface 513 are flush.

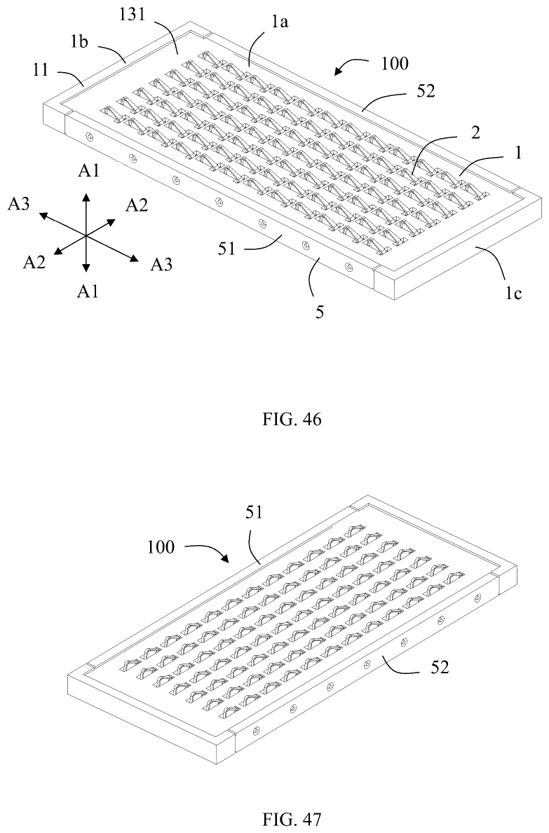

Similarly, the first extension portion 1b includes a third extension protrusion 1b2. The second extension portion 1c includes a fourth extension protrusion 1c2. The insulating body 1 includes a second receiving space 1340 located between the third extension protrusion 1b2 and the fourth extension protrusion 1c2. The second wave-absorbing plate portion 52 is received in the second receiving space 1340. As shown in FIG. 46 to FIG. 51, the board-to-board connector 100 in the seventh embodiment of the present disclosure is substantially the same as the board-to-board connector 100 in the sixth embodiment of the present disclosure, wherein the same reference numbers indicate the same or corresponding technical features. Only the main differences between the two are described below.

In the seventh embodiment of the board-to-board connector 100 of the present disclosure, the insulating body 1 includes a plurality of first posts 1331 extending from the first outer side surface 133 and protruding into the first receiving space 1330, and a plurality of second posts 1341 extending from the second outer side surface 134 and protruding into the second receiving space 1340. The first wave-absorbing plate portion 51 defines a plurality of first through holes 514. The first posts 1331 are inserted into the corresponding first through holes 514. The second wave-absorbing plate portion 52 defines a plurality of second through holes 524. The second posts 1341 are inserted into the corresponding second through holes 524. The first posts 1331 are inserted into the corresponding first through holes 514 to achieve positioning. The second posts 1341 are inserted into the corresponding second through holes 524 to achieve positioning.

Compared with the prior art, the terminal installation area 1a of the present disclosure includes the first outer side surface 133. The board-to-board connector 100 includes the wave-absorbing material 5. The wave-absorbing material 5 is fixed to the insulating body 1. The wave-absorbing material 5 includes the first wave-absorbing plate portion 51 covering at least part of the first outer side surface 133. With this arrangement, the board-to-board connector 100 of the present disclosure can achieve a ground shielding function. Besides, the insulating housing 1 of the present disclosure does not form any slot which is located between two adjacent rows of conductive terminals 2 (i.e., inside the insulating housing 1), extends through the insulating body 1 along the first direction A1-A1, and is configured to install the first wave-absorbing plate portion 51. As a result, this minimizes damage to the structural strength of the insulating body 1 and is suitable for thin board-to-board connectors 100.

The terminal installation area 1a of the present disclosure includes the second outer side surface 134. The wave-absorbing material 5 includes the second wave-absorbing plate portion 52 covering at least part of the second outer side surface 134. With this arrangement, the board-to-board connector 100 of the present disclosure can achieve a ground shielding function. Besides, the insulating housing 1 of the present disclosure does not form any slot which is located between two adjacent rows of conductive terminals 2 (i.e., inside the insulating housing 1), extends through the insulating body 1 along the first direction A1-A1, and is configured to install the second wave-absorbing plate portion 52. As a result, this minimizes damage to the structural strength of the insulating body 1 and is suitable for thin board-to-board connectors 100. It is understandable to those skilled in the art that the slot is a long through hole with a length greater than four times the thickness of the insulating body 1 along the first direction A1-A1. The design of such long through hole can easily significantly weaken the structural strength of the insulating body 1.

In addition, the board-to-board connector 100 of the present disclosure can absorb the noise leaked out of the board-to-board connector 100 through the wave-absorbing material 5 when the conductive terminal 2 transmits signals, thereby improving the quality of signal transmission. Besides, the wave-absorbing material 5 of the present disclosure is disposed on an outer side the board-to-board connector 100, thereby minimizing damage to the structural strength of the insulating body 1, and is suitable for thin board-to-board connectors.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A board-to-board connector, comprising:
an insulating body, the insulating body comprising a first mounting surface, a second mounting surface disposed opposite to the first mounting surface along a first direction, and a terminal installation area; the terminal installation area comprising a first outer side surface;
a plurality of conductive terminals, the plurality of conductive terminal being mounted to the terminal installation area; each conductive terminal comprising a first contact elastic arm extending beyond the first mounting surface and a second contact elastic arm extending beyond the second mounting surface; the first contact elastic arm being configured to be electrically connected to a first circuit board; the second contact elastic arm being configured to be electrically connected to a second circuit board; and
a first ground sheet, the first ground sheet being fixed to the insulating body, the first ground sheet comprising a first main body portion covering at least part of the first outer side surface, a first ground elastic arm extending directly or indirectly from the first main body portion and protruding beyond the first mounting surface, and a second ground elastic arm extending directly or indirectly from the first main body portion and protruding beyond the second mounting surface; the first ground elastic arm being configured to be in contact with the first circuit board; the second ground elastic arm being configured to be in contact with the second circuit board.

2. The board-to-board connector according to claim 1, wherein the terminal installation area comprises a first surface and a second surface disposed opposite to the first surface; the first surface and the first mounting surface are located on a same side of the insulating body, the first mounting surface protrudes beyond the first surface; the second surface and the second mounting surface are located on another same side of the insulating body, the second mounting surface protrudes beyond the second surface.

3. The board-to-board connector according to claim 2, wherein the insulating body defines a first fixing groove; the first ground sheet comprises a first fixing tab bent from the first main body portion; the first fixing tab is inserted into and fixed in the first fixing groove.

4. The board-to-board connector according to claim 3, wherein the insulating body defines a second fixing groove; the first ground sheet comprises a second fixing tab bent from the first main body portion; the second fixing tab is inserted into and fixed in the second fixing groove;
the first fixing tab and the second fixing tab are located at two ends of the first main body portion, respectively.

5. The board-to-board connector according to claim 4, wherein a plurality of first ground sheets are provided; in any two adjacent first ground sheets, the second fixing tab of one of the first ground sheets and the first fixing tab of a remaining one of the first ground sheets are in contact with each other.

6. The board-to-board connector according to claim 2, wherein the first ground sheet comprises a first bending portion bent from one end of the first main body portion and a second bending portion bent from another end of the first main body portion; the first ground elastic arm is connected to the first bending portion; the second ground elastic arm is connected to the second bending portion.

7. The board-to-board connector according to claim 6, wherein the first ground elastic arm is in a shape of a straight strip and extends obliquely; the first ground elastic arm is provided with a first abutting portion located at a free end thereof; the first abutting portion is configured to abut against the first circuit board;
the second ground elastic arm is in a shape of a straight strip and extends obliquely; the second ground elastic arm is provided with a second abutting portion located at a free end thereof; the second abutting portion is configured to abut against the second circuit board.

8. The board-to-board connector according to claim 6, wherein the first main body portion comprises a first end surface and a second end face disposed opposite to the first end face along the first direction; the first end surface is located between the first surface and the first mounting surface along the first direction; the second end surface is located between the second surface and the second mounting surface along the first direction.

9. The board-to-board connector according to claim 8, wherein the first bending portion comprises an upper surface which is located between the first surface and the first mounting surface along the first direction;
the second bending portion comprises a lower surface which is located between the second surface and the second mounting surface along the first direction.

10. The board-to-board connector according to claim 8, wherein the first main body portion defines two first notches recessed from the first end surface and two second notches recessed from the second end surface; the first bending portion is located between the two first notches; the second bending portion is located between the two second notches.

11. The board-to-board connector according to claim 6, wherein the terminal installation area comprises a first fixing hole recessed from the first surface and a second fixing hole recessed from the second surface;
the first bending portion comprises a first holding tab held in the first fixing hole; the second bending portion comprises a second holding tab held in the second fixing hole.

12. The board-to-board connector according to claim 1, wherein the terminal installation area comprises a second outer side surface disposed opposite to the first outer side surface along a second direction; the second direction is perpendicular to the first direction;
the board-to-board connector further comprises a second ground sheet fixed to the insulating body; the second ground sheet comprises a second main body portion covering at least part of the second outer side surface, a third ground elastic arm extending beyond the first mounting surface and a fourth ground elastic arm extending beyond the second mounting surface; the third ground elastic arm is configured to be in contact with the first circuit board;
the fourth ground elastic arm is configured to be in contact with the second circuit board.

13. The board-to-board connector according to claim 12, wherein the first ground sheet is integrated of one piece; the first ground sheet comprises a first fixing portion bent from one end of the first main body portion and a second fixing portion bent from another end of the first main body portion;
the second ground sheet is integrated of one piece; the second ground sheet comprises a third fixing portion bent from one end of the second main body portion and a fourth fixing portion bent from another end of the second main body portion;
the insulating body comprises a third outer side surface and a fourth outer side surface disposed opposite to the third outer side surface along a third direction; both the first fixing portion and the third fixing portion at least partially cover the third outer side surface; both the second fixing portion and the fourth fixing portion at least partially cover the fourth outer side surface; the third direction is perpendicular to the first direction and the second direction.

14. The board-to-board connector according to claim 13, wherein the first fixing portion is in contact with the third fixing portion; the second fixing portion is in contact with the fourth fixing portion.

15. The board-to-board connector according to claim 14, wherein the insulating body comprises a first protrusion protruding beyond the third outer side surface and a second protrusion protruding beyond the fourth outer side surface; the first protrusion defines a first locking groove in which the first fixing portion and the third fixing portion are fixed;
the second protrusion defines a second locking groove in which the second fixing portion and the fourth fixing portion are fixed.

16. The board-to-board connector according to claim 15, wherein the first protrusion comprises a first holding block; the first fixing portion comprises two first clamping arms and a first clamping groove located between the two first clamping arms; the first holding block is received in the first clamping groove; each first clamping arm is provided with a first hook portion protruding into the first locking groove;
the first protrusion comprises a second holding block; the third fixing portion comprises two third clamping arms and a third clamping groove located between the two third clamping arms; the second holding block is received in the third clamping groove; each third clamping arm is provided with a third hook portion protruding into the first locking groove;
the second protrusion comprises a third holding block; the second fixing portion comprises two second clamping arms and a second clamping groove located between the two second clamping arms; the third holding block is received in the second clamping groove; each second clamping arm is provided with a second hook portion protruding into the second locking groove;
the second protrusion comprises a fourth holding block; the fourth fixing portion comprises two fourth clamping arms and a fourth clamping groove located between the two fourth clamping arms; the fourth holding block is received in the fourth clamping groove; each fourth clamping arm is provided with a fourth hook portion protruding into the second locking groove.

17. The board-to-board connector according to claim 1, wherein before installing the first ground sheet, the first outer side surface is exposed to an outside of the insulating body along a second direction; the second direction is perpendicular to the first direction.

18. A board-to-board connector, comprising:
an insulating body, the insulating body comprising a terminal installation area, the terminal installation area comprising a first surface, a second surface opposite to the first surface along a first direction, and a first outer side surface;
a plurality of conductive terminals, the plurality of conductive terminals being mounted to the terminal installation area, each conductive terminal comprising a first contact elastic arm extending beyond the first surface and a second contact elastic arm extending beyond the second surface; the first contact elastic arm being configured to be electrically connected to a first circuit board; the second contact elastic arm being configured to be electrically connected to a second circuit board; and
a wave-absorbing material, the wave-absorbing material being provided on the insulating body, the wave-absorbing material comprising a first wave-absorbing plate portion covering at least part of the first outer side surface; the first wave-absorbing plate portion being disposed adjacent to a ground portion of the first circuit board and/or adjacent to a ground portion of the second circuit board.

19. The board-to-board connector according to claim 18, wherein the wave-absorbing material is fixed to the insulating body by injection molding.

20. The board-to-board connector according to claim 18, wherein the terminal installation area further comprises a second outer side surface, a third outer side surface and a fourth outer side surface; the second outer side surface is disposed opposite to the first outer side surface along a second direction; the fourth outer side surface is disposed opposite to the third outer side surface along a third direction; each two of the first direction, the second direction and the third direction are perpendicular to each other;
the wave-absorbing material is of a frame-shaped configuration; the wave-absorbing material comprises a second wave-absorbing plate portion covering at least part of the second outer side surface, a third wave-absorbing plate portion covering at least part of the third outer side surface, and a fourth wave-absorbing plate portion covering at least part of the fourth outer side surface.
